(19) United States
(12) Patent Application Publication
(10) Pub. No.: US 2026/0051071 A1
(43) Pub. Date: Feb. 19, 2026

(54) MOTION COMPENSATION USING ILLUMINATION SUPERPOSITION

(71) Applicant: GelSight, Inc., Waltham, MA (US)

(72) Inventor: Janos Rohaly, Concord, MA (US)

(21) Appl. No.: 19/367,625

(22) Filed: Oct. 23, 2025

Related U.S. Application Data
(63) Continuation of application No. PCT/US24/26088, filed on Apr. 24, 2024.
(60) Provisional application No. 63/461,463, filed on Apr. 24, 2023.

(51) Int. Cl. G06T 7/507; G06T 3/4053; G06T 5/50; G06T 5/70; G06T 7/11; G06T 7/246; G06T 7/30; G06T 7/586

(52) U.S. Cl. CPC G06T 7/507; G06T 3/4053; G06T 5/50; G06T 5/70; G06T 7/11; G06T 7/248; G06T 7/30; G06T 7/586; G06T 2207/10152; G06T 2207/20081

(57) ABSTRACT

Using the superposition principle of linear systems, a series of images of a surface, captured under different illumination conditions (e.g., different patterns or directions of illumination) can be registered to one another based on an additional, composite illumination image that is captured while illuminating the surface under all of the constituent illumination conditions, e.g., with directional illumination from all directions concurrently or with concurrent illumination using a number of different illumination patterns. Additional images may also be obtained under various combinations of illumination conditions, and used with illumination multiplexing techniques to obtain super-resolution or noise-reduced images of the surface. The individual super-resolution images may be used, in turn, to derive super-resolution or noise-reduced three-dimensional reconstructions based on the improved source images.

### RELATED APPLICATIONS

This application is a bypass continuation that claims priority to International Patent App. No. PCT/US24/26088 filed on Apr. 24, 2024, which claims priority to U.S. Prov. App. No. 63/461,463 filed on Apr. 24, 2023, the entire contents of which are hereby incorporated by reference.

### TECHNICAL FIELD

The present disclosure generally relates to three-dimensional reconstruction, and more specifically to techniques for aligning multiple images of a target surface captured under different illumination conditions.

### BACKGROUND

Shape-from-shading and similar three-dimensional reconstruction techniques permit the recovery of three-dimensional surface information from a number of images of a target surface that are captured under different illumination conditions. However, when the images are captured sequentially over time, camera motion may introduce misalignment among the images, thus introducing misalignment artifacts such as ghosting, blurring, and smearing of three-dimensional features, thus reducing the accuracy of the recovered three-dimensional data. This challenge may be particularly acute in imaging applications such as high-resolution reconstructions using images from a handheld scanner, where the time interval between images is sufficiently long (e.g., greater than fifty milliseconds), and the targeted resolution sufficiently small (e.g., a twenty microns or less), that handshake becomes a significant source of three- dimensional reconstruction error.

There remains a need for motion compensation and improved image registration for shape-from-shading and similar three-dimensional reconstructions in order to address misalignments in a time-separated sequence of source images used for the three-dimensional reconstruction.

### SUMMARY

Using the superposition principle of linear systems, a series of images of a surface, captured under different illumination conditions (e.g., different patterns or directions of illumination) can be registered to one another based on an additional, composite illumination image that is captured while illuminating the surface under all of the constituent illumination conditions, e.g., with directional illumination from all directions concurrently or with concurrent illumination using a number of different illumination patterns. Additional images may also be obtained under various combinations of illumination conditions, and used with illumination multiplexing techniques to obtain super-resolution or noise-reduced images of the surface. The individual super-resolution images may be used, in turn, to derive super-resolution or noise-reduced three-dimensional reconstructions based on the improved source images.

A computer program product described herein includes computer executable code embodied in a non-transitory computer readable medium that, when executing on one or more computing devices, causes the one or more computing devices to perform the steps of capturing a first image of a surface while illuminating the surface from a first direction, capturing a second image of the surface while illuminating the surface from a second direction, capturing a third image of the surface while illuminating the surface concurrently from the first direction and the second direction, and registering the first image to the second image by applying a motion model to at least one of the first image and the second image relative to the third image while minimizing a cost function representing a difference between the third image and a sum of the first image and the second image, thereby providing a registration aligning the first image to the second image according to the motion model.

In some implementations, the cost function is based on differences in pixel values. In some implementations, the cost function is evaluated for a subset of pixels. In some implementations, the cost function is based on an image similarity metric. In some implementations, the cost function is based on a normalized cross-correlation coefficient. In some implementations, the steps include recovering a three-dimensional shape of the surface with shape-from-shading based on the first image and the second image, as aligned according to the registration. In some implementations, minimizing the cost function includes minimizing a difference between pixel values at one or more pixel locations in a first pixel array for the third image and a sum of the first image and the second image at one or more corresponding locations.

In some implementations, the motion model includes a rigid motion model for one or more of rigid translation and rigid rotation. In another aspect, the motion model may include a rigid motion model for image motion induced by six degrees of freedom in a pose of an imaging device capturing the first image, the second image, and the third image. In some implementations, the motion model uses independent motion tracking for one or more subregions of the first image, the second image, and the third image. In some implementations, the motion model uses one or more visible fiducials to track image differences. In some implementations, registering includes registering downsampled instances of the first image and the second image, and calculating motion parameters to register the first image and the second image by scaling up the motion parameters from the downsampled instances to a scale of the first image and the second image. In some implementations, registering includes recursively downsampling, registering, and scaling motion parameters for two or more down-sampled versions of the first image, the second image, and the third image. In some implementations, registering includes dividing a pixel array for each of the first image, the second image, and the third image into a plurality of regions, and selecting, from each of the plurality of regions, one or more pixel locations for evaluating the cost function. In some implementations, registering includes selecting a subset of pixel locations in a pixel array for each of the first image, the second image, and the third image to minimize the cost function. In some implementations, selecting the subset of pixel locations includes selecting at least one of the subset of pixel locations based on a magnitude of the cost function at the one of the subset of pixel locations between the third image and the sum of the first image and the second image.

A method disclosed herein includes capturing two or more images of a surface, each of the two or more images captured under two or more different illumination conditions; capturing a composite image of the surface while illuminated concurrently under each of the two or more different illumination conditions; and registering the two or more images by applying a motion model while minimizing an image difference between the composite image and a sum of the two or more images.

The two or more different illumination conditions may include two or more different illumination directions. The two or more different illumination conditions may include two or more different illumination wavelengths. The two or more different illumination conditions may include two or more different illumination patterns. Minimizing the image difference may include minimizing a cost function representing a difference between the composite image and the sum of the two or more images. Registering the two or more images may include registering the two or more images with a multi-image registration algorithm. Registering the two or more images may include minimizing an optimization function. The two or more images may include three images. The two or more images may include six images. Registering the two or more images may include aligning a first group of the two or more images to one another in a first image registration, registering a second group of the two or more images to one another in a second image registration, and registering the first image registration to the second image registration in a third image registration. The method may include calculating an initial estimate for a displacement of the motion model based on an input from an inertial measurement unit. The method may include calculating an initial estimate for a displacement of the motion model based on one or more fiducials visible in each of the two or more images. The method may include calculating an initial estimate for a displacement of the motion model based on an evaluation by a machine learning model trained to associate one or more predetermined misalignments with one or more visual artifacts in a combination of images illuminated under the two or more different illumination conditions.

A system described herein includes a retrographic sensor including a deformable medium with a sensing surface, the deformable medium formed of an optically clear, deformable material and the sensing surface covering a portion of the deformable medium and the sensing surface providing a reflective surface visible through a second surface of the deformable medium. The system also includes a camera positioned to capture images of the reflective surface through the second surface of the deformable medium. The system also includes an illumination system configured to independently illuminate the sensing surface through the deformable medium from each of three or more directions about an optical axis of the camera, thereby providing directional illumination of the sensing surface. The system also includes processing circuitry configured to control the camera and the illumination system to capture an image of the sensing surface with the camera during an illumination of the sensing surface individually from each of the three or more directions, thereby providing three or more images of the sensing surface, control the camera and the illumination system to capture a composite image of the sensing surface while illuminated concurrently from all of the three or more directions, register the three or more images by applying a motion model while minimizing an image difference between the composite image and a sum of the three or more images, thereby providing a registration aligning the three or more images, and recover a three-dimensional shape of the sensing surface using shape-from-shading.

In another aspect, the illumination system may be configured to illuminate the reflective surface under different illumination conditions, such as with different illumination patterns or at different wavelengths, which may be used with a number of sequential images instead of or in addition to directional illumination to extract three-dimensional data.

The processing circuitry may include a controller for an imaging system including the retrographic sensor, the camera, and the illumination system. The processing circuitry may include a cloud computing resource configured to receive the three or more images and the composite image, to register the three or more images, and to recover the three-dimensional shape of the sensing surface using shape-from-shading and the registration aligning the three or more images. The system may include a substrate for the retrographic sensor, wherein the deformable medium is disposed on the substrate, the substrate is formed of a rigid, optically clear material mechanically supporting the deformable medium, and the substrate is positioned between the deformable medium and the camera. The processing circuitry may be configured to obtain one or more additional images under different illumination conditions and to illumination demultiplex the three or more images, the composite image, and the one or more additional images to obtain surface normal values from the sensing surface at a greater resolution than a nominal resolution of the camera. In this context, it will be understood that the term “illumination demultiplex” is intended to refer to the processing that occurs after image acquisition. In general, images may be multiplexed and demultiplexed, e.g., where the images are multiplexed during image acquisition, and then demultiplexed during image processing, and the system may use either or both of these techniques for three dimensional reconstruction. The processing circuitry may also or instead be configured to obtain one or more additional images under different illumination conditions and to illumination demultiplex the three or more images, the composite image, and the one or more additional images to reduce pixel noise in the three or more images and the composite image.

### BRIEF DESCRIPTION OF THE DRAWINGS

Embodiments of devices, systems, and methods described herein are shown in the following drawings. The drawings are not necessarily to scale, emphasis instead being placed upon illustrating the principles of this disclosure.

FIG. 1 shows an imaging system.

FIG. 2 is a perspective view of a tactile sensor.

FIG. 3 is a side view of the tactile sensor of FIG. 2.

FIG. 4 shows a robotic system using a tactile sensor.

FIG. 5 shows a flowchart of a method for processing images.

FIG. 6 shows an imaging system with a retrographic sensor.

FIG. 7 shows an imaging system.

FIG. 8 shows a cutaway view of an imaging system.

FIG. 9 illustrates a motion compensation technique.

FIG. 10 is a flowchart of a motion compensation method.

FIG. 11 illustrates a sum of images before and after alignment.

FIG. 12 illustrates a comparison of a composite image to a summed image before alignment and a summed image after alignment.

FIG. 13 illustrates a surface normal map and rendered three-dimensional surface with and without motion compensation.

### DETAILED DESCRIPTION

All documents mentioned herein are incorporated by reference in their entirety. References to items in the singular should be understood to include items in the plural, and vice versa, unless a different meaning is explicitly stated or otherwise clear from the context. Grammatical conjunctions are intended to express any and all disjunctive and conjunctive combinations of conjoined clauses, sentences, words, and the like, unless otherwise stated. Thus, the term “or” should generally be understood to mean “and/or” and so forth.

Unless otherwise indicated, recitation of ranges of values herein are not intended to be limiting, referring instead individually to any and all values falling within the stated range, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the claims except where explicitly recited. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

The devices, systems, and methods described herein may include, or may be used in conjunction with, the methods, systems, and devices described in U.S. Pat. No. 10,965,854 issued on Mar. 30, 2021 and Int'l App. No. PCT/US2022/046129, published on Apr. 13, 2023. The entire contents of each of the foregoing is hereby incorporated by reference. In certain aspects, the devices, systems, and methods described herein may be used to improve registration of multiple images used in a shape-from-shading three-dimensional reconstruction, particularly where camera movement might introduce artifacts into a sequence of images. For example, the systems described herein may be useful for aligning a sequence of images captured with, e.g., a robotic end effector, a handheld imaging system, or the like.

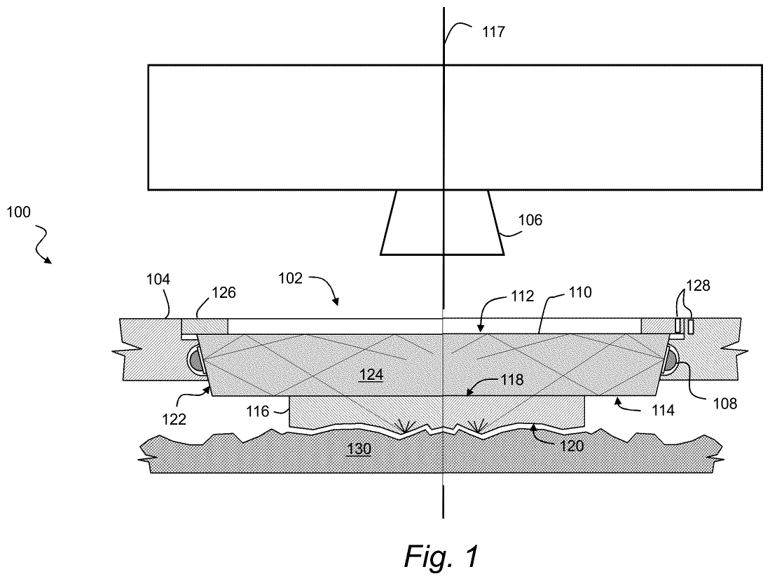

FIG. 1 shows an imaging system. In general, the imaging system 100 may be any system for quantitative or qualitative topographical measurements and/or visualization, such as any of those described in the documents identified above. The imaging system 100 may be used to derive quantitative data from images, such as a surface normal map or a height map of three- dimensional topography. The imaging system may also or instead acquire other contact data such as a force map, an elasticity map, or other measure of softness/hardness of the target surface, and so forth. It will be understood that, while the term “imaging system” is used to describe some of the contemplated embodiments, a tactile sensor may also be deployed in systems that do not generate images, e.g., where raw sensor data is provided to a neural network or other machine learning system for decision making without converting the raw data into any image or quantitative surface reconstruction. All such permutations, combinations, or variations of the foregoing are intended to fall within the scope of this description, and within the scope of an imaging system as described herein, unless explicitly stated otherwise.

In one aspect, the imaging system 100 may include a tactile sensor 102, which may include a removable and replaceable cartridge for the imaging system 100. The imaging system 100 may also include a fixture 104 for removably and replaceably retaining the tactile sensor 102. The fixture 104 may have a predetermined geometric configuration relative to the imaging system 100, and/or relative to an imaging device 106 such as a camera and an illumination source 108 such as one or more light emitting diodes or other light sources, so that the tactile sensor 102, when secured in the fixture 104, has a known position and orientation relative to the imaging device 106 and illumination source 108. This enforced geometry advantageously permits re-use of calibration data for a tactile sensor 102, and facilitates reliable, repeatable positioning of the tactile sensor 102 within an optical train of the imaging system 100. The fixed spatial relationship between the illumination source 108 and the imaging device 106 also provides a useful constraint for certain registration techniques and/or multiplexed illumination. In general, as long as the illumination source 108 remains stationary relative to the imaging device 106, then a sequence of images captured by the imaging device 106 under different illumination conditions can be registered to one another using linear superposition as described herein.

The following description emphasizes the use of a tactile sensor 102 that is removable from and replaceable to the imaging system 100, e.g., configured as a cartridge or the like for modular use and reuse. As such the terms tactile sensor, cartridge, and imaging cartridge are sometimes used interchangeably herein. However, it will also be understood that the tactile sensor 102 or portions thereof may also or instead be integrated into the imaging system 100 in a generally non-removable manner. Thus, advantages of the systems and methods described herein, particularly as they related to superimposed illumination conditions, may apply as well to an imaging system 100 that does not include a tactile sensor 102 that is removable, e.g., that incorporates some or all of the components of the tactile sensor 102 into a body of the imaging system 100 in permanent or non-removable manner. Portions of the tactile sensor 102, such as a rigid substrate may also or instead be integrated into the body of the imaging system 100, while other portions such as a portion that contacts target surfaces or contains a fluid imaging medium may be removable and replaceable in order to permit reuse of the imaging system 100 after the contact surface has become contaminated or damaged with use.

The tactile sensor 102 may include an optical element 110 formed at least in part of a rigid, optically transparent material such as glass, polycarbonate, acrylic, polystyrene, polyurethane, optically transparent epoxy, or any other material with suitable mechanical and optical properties for use in the systems described herein. In this context, and more generally as the term is used herein, it will be understood that “optically transparent” may mean clear within the visible light range, and can also or instead mean clear within a wavelength or range of wavelengths of interest. Thus, for example, where imaging is performed in the infrared range, a “clear” material will transmit most of the incident light in the infrared range. As another example, imaging may usefully be channelized or multiplexed using different ranges of wavelengths, and the optical element 110 may be clear for these aggregated ranges of wavelengths, or may include multiple components, each clear at one or more different ones of the wavelength ranges. It should also be understood that “clear,” in this context means sufficiently transmissive to capture images. This may generally be understood as, e.g., greater than ninety percent transmissive, with less than ten percent combined reflection and absorption over the wavelengths of interest. However, an optical element 110 with transmissivity less than ninety percent may also be used, e.g., due to specific material or cost constraints, provided the optical element 110 transmits sufficient light to support imaging with the imaging system 100 with a resolution satisfying the intended use.

The imaging system 100 may include an illumination source 108, such as one or more LEDs or other light sources positioned to direct illumination into the optical element 110 and/or toward the layer 116 of deformable material. This may include LEDs of different wavelengths and intensities, as well as lenses, filters, or other light shaping features to direct illumination from the LEDs in a manner suitable for three-dimensional reconstruction as described herein. While LEDs provide a low-cost, narrowband source of illumination, the illumination source 108 may also or instead include other light sources such as fluorescent light sources, incandescent light sources, laser light sources, or a fiber optic or the like directing an external light source into the imaging system 100 at one or more suitable locations.

In general, the optical element 110 may form a substrate for the tactile sensor 102, or the optical element 110 may be a window or the like within a larger mechanical substrate for the tactile sensor 102, i.e., where a window of optically clear material is embedded in another structure for attaching to the fixture 104 or other components of the imaging system 100. In one aspect, the optical element 110 may be formed of a silicone such as a hard platinum cured silicone, or any other optical quality polymer. The optical element 110 may have a first surface 112 including a region with an optically transparent surface for capturing images through the optical element 110, e.g., by the imaging device 106. The optical element 110 may also have a second surface 114 opposing the first surface 112, with a center axis 117 passing through the first surface 112 and the second surface 114. The center axis 117 may, for example, overlap or be parallel to an optical axis of the imaging system 100.

In general, the first surface 112 may have optical properties suitable for conveying an image (or more generally, optical rays) from the second surface 114 through the optical element 110 to the imaging device 106. To support this function, the first surface 112 may, for example, include a curvature providing a lens to optically magnify, focus, or otherwise modify an image from the second surface 114. For example, the first surface 112 may include an aspheric surface shaped to address spherical aberrations or other optical aberrations in an image captured through the optical element 110 from the second surface 114. The first surface 112 may also or instead include a freeform surface shaped to reduce or otherwise mitigate geometric distortion in an image captured through the optical element 110. For example, imaging through a thick medium may generally lead to spherical aberration with a magnitude depending on a numerical aperture of the imaging system 100 (or more specifically here, the imaging device 106). Thus, the first surface 112 of the optical element 110 may be curved or otherwise adapted to address spherical aberrations (and other higher order aberrations) resulting from propagation of focused ray bundles through thick media. More generally, the first surface 112 may include any shape or surface treatment suitable to focus, shape, or modify the image in a manner that supports capture of optical data through the optical element 110. The second surface 114 may also or instead be modified to improve image capture. For example, the second surface 114 of the optical element 110 may include a convex surface extending from the optical element 110 (e.g., toward the target surface 130 being imaged) in order to magnify or otherwise shape an image conveyed from the target surface 130 to the imaging device 106. More generally, the first surface 112 may include any light shaping features such as filters, lenses, focusing curvatures, diffusers, and so forth, suitable for facilitating imaging as described herein.

The optical element 110 may generally serve a number of purposes in an imaging system 100 as contemplated herein. In one aspect, the optical element 110 serves as a rigid body to transfer pressure relatively uniformly across a target surface 130 when capturing images. Specifically, the body of the optical element 110 may apply a substantially uniform or continuous pressure on an imaging medium such that a reflective membrane coating on the other side of the imaging medium conforms to the topography of a surface being measured. In one aspect, the optical element 110 may provide a grazing or shallow angle illumination, e.g., from an illumination source 108 at one or more locations along the edge thereof. The optical element 110 may also or instead provide directional dark field illumination. To this end, a sufficiently thick optical material may be used, and may function as a light guide to provide controlled, uniform illumination, and to provide collimated or near-collimated dark field or grazing illumination of the reflective membrane surface from distinct directions (e.g., when a single LED segment of the illumination source 108 is on) or from all around (e.g., when all LED segments of the illumination source 108 are on). This configuration for grazing illumination may be useful, for example, when the illumination source 108 includes colored LEDs that are used to multiplex optical channels for multi-spectral photometric stereo in which each color is associated with a specific illumination direction.

A layer 116 of optically transparent elastomer or other clear, deformable material may be disposed on the second surface 114 and attached to the second surface 114 using any suitable means, such as any of those described herein. In general, the layer 116 may be formed of a gel or other relatively pliable material that is capable of deforming to match a topography of a target surface 130 so that the complementary shape formed in the layer 116 can be optically captured through an opposing surface of the layer 116. For example, an elastomer with a Shore OO durometer value of about 5-60 may usefully serve as the layer 116 contemplated herein. Other materials, including fluids, gels, elastic polymers, and the like may also or instead be used, provided they are sufficiently optically clear for imaging and sufficiently soft to conform to a target surface. In one aspect, a first side 118 of the layer 116 that is adjacent to the second surface 114 of the optical element 110 may have an index of refraction that is matched to the index of refraction of the second surface 114. It will be appreciated that, as used herein when referring to indices of refraction, the term “matched” does not require identical indices of refraction. Instead, the term “matched” generally means having indices of refraction that are sufficiently close to transmit images through a corresponding interface between two materials for capture by the imaging device 106. Thus, for example, acrylic has an index of refraction of about 1.49 while polydimethylsiloxane has an index of refraction of about 1.41 and these materials are sufficiently matched that they can be placed adjacent to one another and used to transmit images therebetween with sufficient intensity and focus for quantitative or qualitative topographical measurements as contemplated herein.

A second side 120 of the layer 116 may be configured to conform to a target surface 130 while providing a surface facing the imaging device 106 that facilitates topographical imaging and measurements by the imaging system 100. The second side 120 may, for example, include an opaque or reflective coating, or more generally, any optical coating with a predetermined reflectance suitable for supporting topographical imaging as contemplated herein. In general, this coating can facilitate capture of images that are independent of the optical properties of the target surface 130 so that surface properties such as color, translucence, gloss, specularity, and the like do not interfere with optical intensity measurements. In one aspect, the second side 120 may include a convex surface extending away from the optical element 110 (e.g., toward the target surface 130). This geometric configuration can provide numerous advantages such as facilitating imaging of surfaces with large, aggregate concave shapes, and mitigating an accumulation of air bubbles within the field of view when the tactile sensor 102 is initially placed in contact with a target surface 130.

A sidewall 122 may be formed around an interior 124 of the optical element 110 extending from the first surface 112 to the second surface 114. In general, the sidewall 122 may include one or more light shaping features configured to control an illumination of the second surface 114 through the sidewall 122, e.g., from the illumination source 108. The sidewall 122 may assume a variety of geometries useful for light shaping, e.g., to steer light at desirable angles and uniformity into and through the optical element 110. For example, the sidewall 122 may include a continuous surface forming a frustoconical shape between two circles formed in the first surface 112 and the second surface 114. The sidewall 122 may also or instead include a truncated hemisphere between some or all of the region between the first surface 112 and the second surface 114. In another aspect, the sidewall 122 may include two or more discrete planar surfaces arranged into a regular or irregular polygonal geometry such as a hexagon or an octagon about the center axis 117, e.g., forming a truncated hexagonal or octagonal pyramid. In this latter embodiment with planar surfaces, the illumination source 108 may be formed by a number of light emitting diodes adjacent to each of the planar surfaces, or adjacent to two or more of the planar surfaces. This arrangement can usefully support multi-directional side lighting through the optical element 110. It should be understood that in this context, a planar surface may also serve as a light shaping feature where the plane refracts or filters light rays and/or otherwise controls illumination in a desired manner within an imaging volume of the imaging system 100.

Other light shaping features may also or instead be incorporated into the sidewall 122, e.g., to focus or steer incident light from the illumination source 108, or to control reflection of light within the optical element 110 and/or the layer 116 of optically transparent elastomer. For example, the light shaping feature(s) may include a diffusing surface to diffuse point sources of incoming light along the sidewall 122. This can diffuse light from individual light emitting diode elements in the illumination source 108, and/or provide a more uniform illumination field from a planar surface of the sidewall 122. The sidewall 122 may also or instead include a polished surface to refract incoming light into the optical element 110. It will be appreciated that diffusing and reflecting surfaces may also be used in various combinations to shape illumination within the optical element 110. The sidewall 122 may also or instead include a curved surface, e.g., forming a lens within the sidewall 122 to focus or steer incident light into the optical element 110 as desired.

In another aspect, the sidewall 122 may include a neutral density filter with graduated attenuation to compensate for a distance from the sidewall 122. For example, in order to avoid over-illumination of regions of the second surface 114 near the sidewall 122, and/or under-illumination of regions of the second surface 114 more distant from the sidewall 122 (and/or closer to the center axis 117), the sidewall 122 may include a neutral density filter that provides greater attenuation in areas of the sidewall 122 closer to the second surface 114 and less attenuation in areas of the sidewall 122 closer to the first surface 112. In this manner, light rays directly illuminating the second surface 114 at a downward angle adjacent to the sidewall 122 may be more attenuated than other light rays exiting the illumination source 108 toward the center of the second surface 114. This attenuation may, for example, be continuous, discrete, or otherwise graduated to provide generally greater attenuation for light directed closer to the sidewall 122 or to otherwise balance illumination within the field of view.

In another aspect, the light shaping feature(s) may include one or more color filters, which may usefully be employed, e.g., to correlate particular colors to particular directions of illumination within the optical element 110, or otherwise control use of colored illumination from the illumination source 108. Where the imaging system uses wavelength-multiplexed imaging, color filters on the sidewalls may also reduce stray lighting within the cartridge by selectively reflecting or transmitting frequency ranges of interest. In another aspect, the light shaping feature may include a non-normal angle of the sidewall 122 to the second surface 114. For example, as illustrated in FIG. 1, the sidewall 122 is angled away from the second surface 114 to form an obtuse angle therewith. This approach may advantageously support indirect illumination of the second surface 114, e.g., by total internal reflection of light off of the first surface 112 and into the optical element 110. In another aspect, the sidewall 122 may be angled toward the second surface to provide an acute angle therewith, e.g., in order to support greater direct illumination of the second surface 114. These approaches may be used alone or in combination to steer light as desired into and through the optical element 110.

The light shaping feature(s) may also or instead include a geometric feature such as a focusing lens, non-planar regions, or the like to direct incident light as desired. Other optical elements may also or instead be formed onto or into the sidewall 122. For example, the light shaping feature may include an optical film such as any of a variety of commercially available films for filtering, attenuating, polarizing, or otherwise shaping the incident light. The light shaping feature(s) may also or instead include a micro-lens array or the like to steer or focus incident light from the illumination source 108. The light shaping feature(s) may also or instead include a plurality of micro-replicated and/or diffractive optical features such as lenses, gratings, or the like. For example, the sidewall 122 may include a microstructured sidewall including, e.g., microimaging lenses, lenticulars, microprisms, and so on as light shaping features to steer light from the illumination source 108 into the optical element 110 in a manner that improves imaging of topographical variations to the imaging surface of the tactile sensor 102 on the second side 120 of the layer 116 of optically transparent elastomer. For example, microstructured features facilitate shaping the illumination pattern to provide uniform light distribution across the measured field, reduce the reflection of light back into or out of the optical element 110, and so forth. Microstructuring may, for example, be imposed during injection molding of the optical element 110, or by applying an optical film with the desired microstructure to the side surface. For example, one commercially suitable optical film for applying surface microstructuring includes Vikuiti™, an advanced light control film (ALCF) sold by 3M.

It will be understood that other surfaces of the optical element 110, such as the top (facing the imaging device 106) or the bottom (facing the target surface 130) may also or instead include any of the foregoing optical treatments, structures, and so forth, which may be used alone or in combination to control illumination into, out of, or within the optical element 110 to support imaging as described herein.

A mechanical key 126 may be disposed on an exterior of the optical element 110 for enforcing a predetermined position of the optical element 110 (and more generally, the tactile sensor 102) within the fixture 104 of the imaging system 100. The mechanical key 126 may, for example, include at least one radially asymmetric feature about the center axis 117 for enforcing a unique rotational orientation of the optical element 110 within the fixture 104 of the imaging system 100. The mechanical key 126 may more generally include any number of mechanical elements or the like suitable for retaining the optical element 110 in a predetermined orientation and/or position within the imaging system 100. The mechanical key 126 may also or instead include a matched geometry between the optical element 110 and the fixture 104. For example, the mechanical key 126 may include a cylindrical structure extending from the optical element 110, and/or the mechanical key 126 may include an elliptical prism or the like, which may usefully enforce a rotational orientation concurrently with position.

In one aspect, the mechanical key 126 may include one or more magnets 128, which may secure the optical element 110 in the fixture 104 of the imaging system 100. The one or more magnets 128 may be further encoded via positioning and/or polarity to ensure that the optical element 110 is only inserted in a particular rotational orientation about the center axis 117. The mechanical key 126 may also or instead include a plurality of protrusions including at least one protrusion having a different shape than other ones of the plurality of protrusions for enforcing the unique rotational orientation of the optical element 110 about the center axis 117 within the fixture 104 of the imaging system 100. The mechanical key 126 may also or instead include at least three protrusions (e.g., exactly three protrusions) shaped and sized to form a kinematic coupling with the fixture 104 of the imaging system 100. The mechanical key 126 may also or instead include features such as a flange, a dovetail, or any other mechanical shape(s) or feature(s) to securely mate the optical element 110 to the fixture 104 in a predetermined position and/or orientation. More generally, any combination and arrangement of mechanically mating features may be used to provide a mechanical key 126 that physically orients the tactile sensor 102 within the imaging system 100.

Surfaces of the tactile sensor 102 may be further treated as necessary or helpful in acquiring images with the imaging system 100. For example, regions of the top, side, and bottom surfaces of the optical element 110 or other portions of the tactile sensor 102 may be covered with a light absorbing layer, such as a black paint, e.g., to contain light from the illumination source 108 or to reduce infiltration of ambient light.

One challenge to securing a flexible elastomer (in the layer 116) to a rigid surface such as the optical element 110 is delamination, which can result from shear forces and other edge effects after repeated compression, decompression, and shearing of the layer 116 during image capture, particularly where the target surface 130 tends to adhere to the elastomer. To address this issue, the optical element 110 and the layer 116 of clear elastomer may be formed as a cartridge that is provided for end users as an integral, removable, and replaceable device. In embodiments, this cartridge can be removed and replaced by an end in order to change to a tactile sensor 102 with different optical properties, e.g., for a different imaging application, resolution, or the like, or in order to replace a tactile sensor 102 that is worn or damaged. At the same time, concurrent replacement of the optical element 110 with the layer 116 permits more robust attachment of the layer 116 of elastomer to the optical element 110 when compared to configurations where a user manually replaces only the layer 116 of elastomer.

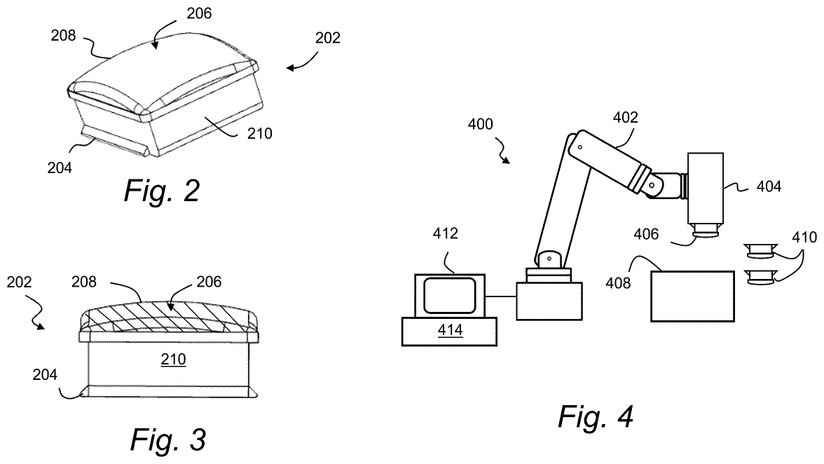

FIG. 2 is a perspective view of a tactile sensor. The tactile sensor 202 may, for example, have a generally rectangular construction, and may include one or more flanges 204 or the like so that the tactile sensor 202 can linearly slide into engagement with a fixture of a housing. This type of engagement mechanism may be particularly suited to robotic applications or the like, where the tactile sensor 202 might be removed from and replaced to an end effector of a robotic handler. The tactile sensor 202 may be any of the tactile sensors described herein. A deformable layer 206, such as any of the fluid, elastomeric, or other deformable layers described herein, may provide an optically transparent medium, a membrane 208 for contact with a target surface, and a substrate 210 for mechanical support.

FIG. 3 is a side view of the tactile sensor of FIG. 2.

FIG. 4 shows a robotic system using a tactile sensor. In general, the system 400 may include a robotic handler 402 with a housing 404 on an end thereof that is configured to removably and replaceably receive a tactile sensor 406 such as a cartridge or any of the other tactile sensors or other optical devices described herein. In general, the robotic handler 402 may include any robotic component or combination of components suitable for positioning and manipulating objects. For example, the robotic handler 402 may include a robotic arm, a gantry, a SCARA robot, a Cartesian robot, a delta arm, or any combination of these or other positional controllers, along with suitable sensors, actuators and the like to control movement thereof. The robotic handler 402 may also include any suitable manipulators, grippers, end effectors or the like for grasping or otherwise handling and manipulating objects. The system 400 may also include a processor or other controller or the like for providing a programmatic interface or user interface to control operation of the robotic handler 402.

The robotic handler 402 may be configured to position the tactile sensor 406 in contact with a target surface 408 in order to capture topographical images of the target surface 408 using, e.g., a camera or other imaging device in the housing 404. It will be appreciated that components of such an imaging device may generally be within the housing 404, or positioned remotely and optically coupled, e.g., by optical fibers or the like, to the tactile sensor 406, or some combination of these. In one aspect, the system 400 may be configured, e.g., by computer executable code stored in a memory of the system 400 and executed by a processor of the system 400, to automatically remove the tactile sensor 406 from a fixture of the system 400 (e.g., in the housing 404), and to insert a second tactile sensor 410 that has a replacement sensor into the housing 404. The second tactile sensor 410 may be the same in structure and function as the tactile sensor 406, e.g., to provide a replacement after ordinary wear and tear, or the second tactile sensor 410 may have a different optical configuration than the tactile sensor 406, e.g., to provide greater magnification, a larger field of view, better feature resolution, deep feature illumination, different aggregate surface shape, and so forth. The second tactile sensor 410 may be stored in a bin or other receptacle accessible to the robotic handler 402 of the system 400. In general, the system 400 may include one or more magnets, electromechanical latches, actuators, and so forth, within the housing 404, or more generally within the system 400, to facilitate removal and replacement of the tactile sensor 406 as described herein. More generally, the system 400 may include any gripper, clamp, or other electromechanical end effector or the like suitable for removing and replacing the tactile sensor 406 and positioning the tactile sensor 406 for use in an imaging process.

In one aspect, the robotic handler 402 may be manually operated by a human technician from a console or the like. The robotic handler 402 may also or instead be programmed to operate automatically, e.g., in a testing or manufacturing facility. In this context, the robotic handler 402 may, for example, automatically position the tactile sensor 406 on a workpiece of interest using sensing networks, machine learning algorithms, and other techniques, and may, e.g., control contact force, fluid pressure, temperature, or other parameters in preparation for a measurement and/or while acquiring image data. After proper positioning, the robotic handler 402 may control an imaging system (also in the housing 404, or accessible therefrom) to acquire data for a three-dimensional reconstruction of a target surface of the workpiece. This general technique may be used, e.g., for parts inspection, metrology, and so forth.

In another aspect, the robotic handler 402 may use tactile feedback to guide decision-making. For example, the robotic handler 402 may determine whether the workpiece satisfies certain physical requirements, and may then sort the workpiece into acceptable, unacceptable, and/or undetermined (e.g., requiring manual inspection). In another aspect, the robotic handler 402 may use tactile feedback from the tactile sensor 406 to control grip strength for a robotic hand, gripper, or other end effector or the like, or to control an amount of instantaneous contact force, torque, or the like applied to a workpiece that is being manipulated by the robotic handler 402. In another aspect, the tactile sensor 406, which may include an array of tactile sensors, may be used to create a visualization of a contact force field, pressure field, or surface topology which can be presented in a display 412 to a human operator in order to assist the operator in controlling actions by the robotic handler 402 with respect to a workpiece. In another aspect, the tactile sensor 406 may be used to quantify a contact force field, pressure field, or surface topology for use by the robotic handler 402 in automatically adjusting grip strength, grip orientation, and the like, or in determining whether a sufficient grip is present to initiate a next step (e.g., moving a workpiece).

The system 400 may include a computing device 414 to process data from the tactile sensor 406, to control operation of the robotic handler 402, to provide a user interface for the robotic handler 402, and so forth. For example, the computing device 414 may be configured, e.g., by code stored in a memory and executing on a processor of the computing device 414, to identify objects or surfaces contacted by the tactile sensor 406 of the robotic handler 402, to generate alerts to a user based on tactile feedback acquired from the tactile sensor 406, to decide upon an action for a workpiece contacting the tactile sensor 406 (including decisions recommended to a user, and decisions automatically executed by the robotic handler 402), and so forth. In one aspect, the code may employ, e.g., machine learning models or the like for identification, decision-making, and other intelligent sensing and/or data-driven operations.

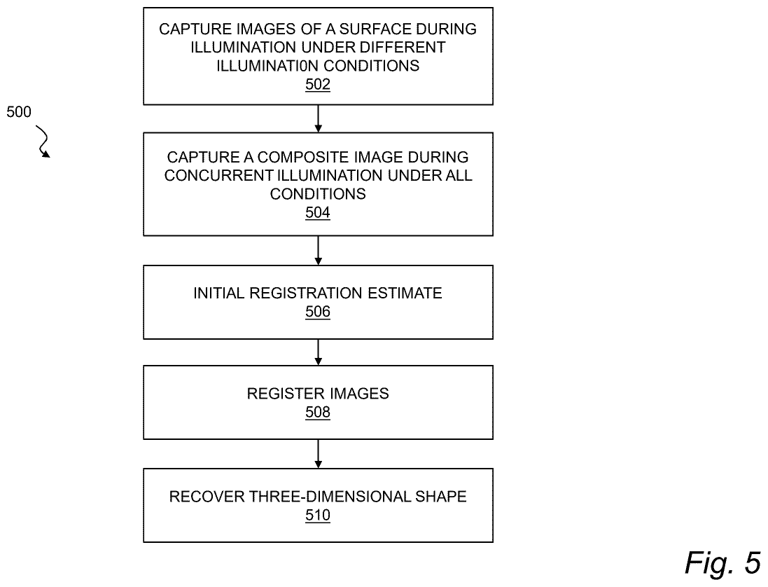

FIG. 5 shows a flowchart of a method for processing images. Using the superposition principle of linear systems, a series of images of a surface, captured under different illumination conditions can be registered to one another based on an additional, composite illumination image that is captured while the surface is illuminated under all of the different illumination conditions concurrently. For example, where directional illumination is used, this may include illuminating the surface from each direction individually to acquire a series of directionally illuminated images, and then providing directional illumination from all of the directions concurrently while capturing a composite image of the surface. Additional images may also be obtained under various combinations of illumination conditions, e.g., various combinations of directional illumination, and used with illumination multiplexing techniques to obtain noise-reduced images of the surface. These same techniques may also or instead be used to obtain super-resolution images based on differences in the registered image source images. The registered images may then be used with shape-from-shading, structured light, photometric stereo, and like to obtain corresponding noise-reduced and/or super-resolution three-dimensional reconstructions.

The method 500 may in general be performed using the devices and other methods described herein. For example, the method 500 may be performed using an imaging system that includes a tactile sensor. In one aspect, the imaging system may include a handheld imaging device as described herein, and motion compensation with the techniques described herein may advantageously be used to address handshake accompanying manually acquired images. The method 500 may be performed, e.g., by computer executable code stored on a non-transitory computer readable medium that, when executing on one or more computing devices, causes the one or more computing devices to perform the steps described below.

As shown in step 502, the method 500 may include capturing images of a surface under a number of different illumination conditions. For example, this may include capturing images during directional illumination from two or more different directions. For example, a first image of the surface may be captured while the surface is illuminated from a first direction, and a second image of the surface may be captured while the surface is illuminated from a second direction. More generally, a number of directional illumination images may be captured, e.g., to facilitate disambiguation of surface normals (for shape-from-shading), to address occlusions, and to otherwise support accurate recovery of three-dimensional surface data. Thus, more than two images may be captured during illumination from different directions, with each image being captured during illumination from a different one of the illumination directions. For example, this may include capturing six images, each illuminated from a different side direction, which has been demonstrated to support high resolution three-dimensional reconstructions based on surface normals. In some embodiments, a minimum of three images of the surface are captured during illumination of the surface from the different directions, and in some embodiments, more than six images may be used.

In another aspect, the two or more different illumination conditions may include two or more different illumination wavelengths. That is, capturing two or more images of the surface under a number of different illumination conditions may include capturing images of the surface under illumination at two or more different illumination wavelengths. It will be understood that illumination at different wavelengths may be used instead of, or in addition to, illumination from different directions. In another aspect, the two or more different illumination conditions may include two or more different illumination patterns. Thus, for example, structured or patterned illumination may be created using, e.g., lenses, filters, diffractive optical elements, or other techniques, and these illumination patterns may be used to extract three- dimensional surface information. In this case, a series of different illumination patterns may be used, and then all of the different illumination patterns may be projected at once in order to obtain a composite image. Structured illumination may include any suitable illumination pattern(s) such as dots (including random dots and/or ordered dots), lines, sinusoidal patterns (e.g., with predetermined spatial frequencies, polygons, circles, textures), and so forth, any of which may be applied in various sequences from one or more different directions to facilitate three dimensional reconstruction. The principles of superposition may suitably be employed as described herein to align multiple images captured under these different illumination patterns.

As shown in step 504, the method 500 may include capturing an image of the surface while illuminated concurrently under each of the two or more different illumination conditions. For example, for directional lighting this may include capturing a composite image while illuminating the surface from each of the different directions used in the directionally illuminated images of step 502. More generally, a composite image may include images captured while concurrently illuminating from different directions, with different patterns, and/or at different wavelengths. While a single composite image may be used to address inter-image motion, it will be appreciated that additional composite images may also be used, e.g., where each composite image is associated with a different combination of illumination conditions. Thus, for example, where there are six directional light sources, one composite image may be captured during illumination with one group of three of the six light sources, and a second composite image may be captured during illumination with the other group of three of the six light sources. Finally, a third composite image may be captured with illumination from all directions, e.g., to permit alignment across the first and second composite images. This general technique of capturing multiple composite images under different illumination conditions can more generally be used, e.g., to facilitate hierarchical registration, avoid local minima during optimization, increase robustness of the registration process, and so forth. It will be appreciated that, while a composite image is referred to occasionally herein as a “third” image, this is not intended to suggest a particular order of image acquisition, and a composite image may be captured before, amidst, or after the acquisition of other images under single illumination conditions, and/or interlaced with acquisitions of other groups of images. It will also be understood that where movement between images becomes too large, superposition may no longer yield meaningful image combinations. As such a time between single-condition images and corresponding composite images may be constrained in order to facilitate use of superposition for the extraction of improved resolution images, and/or physical motion may be measured and used as a threshold for superposition-based image registration.

As shown in step 506, the method 500 may include obtaining an initial registration estimate. An initial registration estimate may be obtained, for example, using any suitable source(s) of supplemental data. In one aspect, the method 500 may include calculating an initial estimate for a displacement of the motion model based on an input from an inertial measurement unit (such as an inertial measurement unit coupled to a handheld sensor) or other sensor, device, or system that enables spatial tracking of the device. Registering the images may also or instead include calculating an initial estimate for a displacement of the motion model based on an evaluation by a machine learning model trained to estimate a misalignment based on visual artifacts in a combination of images illuminated from the two or more corresponding illumination directions. For example, this model may be trained by capturing sequences of images with various predetermined patterns of misalignment, and then training the machine learning model to classify or predict the nature of the misalignment based on visual artifacts in a composite image formed therefrom. In general, providing an initial estimate, particularly a high quality estimate, can speed the optimization process by starting closer to an ideal registration and helping to avoid local minima that might otherwise trap an optimization process and/or produce erroneous results. As another advantage, a measured initial estimate can help to ensure that images are sufficiently close in alignment to support an assumption of linear superposition. It will also be understood that, where measurements are not available for an initial estimate, an initial estimate may nonetheless be provided based on, e.g., patterns or history of inter-image misalignment, e.g., for a particular device, for a particular user, for a particular imaging application, and so forth.

Fiducials may also or instead be used for obtaining an initial registration estimate. For example, the method 500 may include calculating an initial estimate for a displacement of a motion model based on one or more fiducials visible in each of the two or more images. In one aspect, this may include a pattern of fiducials that is visible in a specific spectral band, along with a camera having pixels that are sensitive in that spectral band (possibly only in that spectral band). Thus, for example, this may include creating a pattern on the contact surface of the sensor with an infrared-absorbing or infrared-reflecting pigment, and then capturing an image of the contact surface in the infrared spectrum. In this manner, some or all of the images, including individually illuminated and composite images, can be decomposed into an infrared image containing fiducials for initial registration to other images, and another image (e.g., a red, green, blue image or the like) for use in three-dimensional reconstruction. In another aspect, a separate optical channel (e.g., using wavelengths outside the range for reconstruction) may be used to provide coarse alignment of fiducials for an initial motion estimate.

As shown in step 508, the method 500 may include registering the images. In general, the images captured during illumination of the surface under different conditions (e.g., the first image and the second image) may be registered to one another using a composite image and the principle of superposition so that they are better aligned to one another before using intensity data therein to calculate surface normals at locations across the surface, or otherwise perform calculations for three-dimensional reconstruction based on the images. Registering the images may include applying an initial registration based on the estimate obtained in step 506.

To perform the registration for directional illumination, the directionally illuminated images may first be summed together. Assuming that the imaging system has a linear response, the sum of the directionally illuminated images, on a location by location (e.g., pixel-by-pixel) basis, should equal an intensity of the composite image at each corresponding location. In practice, exposure or illumination time of one or more of the images may be shortened (or lengthened, as appropriate) in order to maximize the pixel dynamic range for the single- illumination images, while avoiding saturation of the multiplexed images. In this case, a pixel intensity scale factor may be used to compensate for the differences in exposure time, and/or each image may be assigned a scale factor or weight to permit direct combinations of pixel intensities among images. Thus, in general, a simple sum of pixel intensities may be used, or a scaled sum may be used, e.g., to account for differences in exposure time or the like between images. In general, differences between the composite image and the sum (or scaled sum) of directionally illuminated images provides a basis for identifying misalignments among the directionally illuminated images. By translating or otherwise moving the images relative to one another using a motion model, while optimizing a cost function that measures similarity (or difference) to the composite image, a correct registration may be obtained.

While directional illumination is described here, it will be understood that other types of illumination conditions such as structured light or wavelength multiplexing may also or instead be used to provide illumination under different conditions, and then to provide concurrent illumination for acquisition of a composite image. Thus, for example, for structured light, the individually illuminated images under each illumination pattern may be summed together and compared to a composite image that is illuminated with all of the illumination patterns used for the individual images. Assuming that the imaging system has a linear response, the sum of the differentially illuminated images, on a location by location (e.g., pixel-by-pixel) basis, should equal an intensity of the composite image at each corresponding location.

In one aspect the registration process may include pre-processing of image data to support more efficient optimization. For example, this may include reducing the resolution of the registration process, e.g., by downsampling the image for an initial registration and then upsampling the resulting motion parameters to provide a more accurate initial estimate for registration of the full-resolution images. In another aspect, pre-processing of image data may include selecting a subset of pixels for registration based on, e.g., texture, location, and so forth.

In general, an optimization to locate a correct registration of two or more images may be performed by moving the images relative to one another with a predetermined motion model. This may, for example, include a rigid motion model that applies rigid translation and/or rigid rotation to images. This may also or instead include a deformable motion model that accommodates local deformation or the like across a registration region. For example, when imaging with a retrographic sensor that has a conformable contact surface, the contact surface may stretch, slide, or otherwise move in non-rigid manners as the contact surface slowly adapts to the shape of a target surface. In this case, a deformable motion model may usefully be employed to account for non-rigid changes along a sensor-target interface. In another aspect, the motion model may use independent motion tracking for one or more subregions of the various captured images, or any other techniques suitable for tracking specific surface locations between the images. More generally, any motion model suitable for characterizing motion that might occur during imaging, e.g., due to handshake or other sources of unwanted motion, may be used for motion compensation as described herein.

In one aspect, the choice of motion model may be optimized for a particular measurement context. For example, the contact-based tactile sensors described herein are generally applied to a target surface perpendicularly. If this holds as a constraint, then the dominant motion will typically be constrained to three degrees of freedom-x translation, y translation, and z rotation, while z translation, x rotation, and y rotation will tend to be physically constrained and limited. In this case, a suitably simplified rigid motion model may usefully be deployed to simplify registration calculations. However, with imaging techniques using a perspective lens, where contact or perpendicularity is not enforced, proper compensation may require a rigid motion model that accounts for additional degrees of freedom, and possibly three degrees of translational freedom and three degrees of rotational freedom for the imaging device. Thus in one aspect, motion compensation as described herein may use a rigid motion model with six degrees of freedom, such as a rigid motion model including motion induced by six degrees of freedom for the pose of an imaging device that captures the individual and composite images.

It will be understood that, while rigid motion models are emphasized in the preceding paragraph, other motion models may also or instead be used. For example, the motion model may include a non-rigid or deformable motion model to facilitate image alignment, e.g., when the target surface or an interface between the target surface and the sensor is soft or deformable. While deformable motion models tend to be more computationally intensive, techniques such as finite element methods, mesh-based techniques, and statistical models can provide improved accuracy where a deformable model is appropriate, particularly where rigid motion assumptions are inaccurate or unreliable. This may be useful, for example, when imaging human skin or tissue, or when imaging non-rigid objects such as elastic foams, soft rubbers, and the like. This may also be appropriate where target surfaces have irregular surface friction that might cause localized shearing or other deformation in the sensor. More generally, a variety of motion models are known in the art, and may be adapted for use according to the properties of the actual or expected target surface from which images are being captured.

In general, the registration may be performed by iterating motion parameters with the selected motion model while evaluating the superposition of the different images. In order to evaluate the success (or failure) of a particular image displacement, a cost function may be provided. The cost function may generally evaluate a similarity or difference between two images, and may provide an objective measure for determining whether pictures are better aligned (e.g., when the composite image is more similar to the sum of the other images) or worse aligned (e.g., when the composite image is less similar to the sum of the other images). The cost function may be based on differences in pixel values. In one aspect, the cost function may be evaluated for a subset of pixels, which can advantageously reduce processing complexity. The cost function may also or instead be based on an image similarity metric (e.g., a nearness in value between intensities at an image location). In another aspect, the cost function may use a cross-correlation coefficient for two images to measure similarity based on, e.g., normalized and/or windowed images. Thus in one aspect, the cost function may be based on a normalized cross-correlation of the two images. More generally, minimizing the cost function may include minimizing a difference between pixel values at one or more pixel locations in a first pixel array for the composite image and a sum of corresponding one or more pixel locations in a second pixel array for each of a number of individual, non-composite images captured at step 502.

In another aspect, processing efficiency may be improved by selecting a subset of pixels for performing each registration/optimization. A number of strategies may be used to select pixels. In one aspect, this may include subdividing images into regions (e.g., on a grid), and then picking specific or random pixels to use in registration. However, this naïve approach may be significantly improved by selecting specific pixels/regions of interest. For example, this may include selecting one or more pixels where the cost function is high for the sum of the unaligned or initially-aligned images relative to the composite image, e.g., where there is high information relative to a misalignment. In another aspect, the image may be divided into subregions, and one or more such high-cost pixel locations may be selected for each subregion. According to the foregoing, registration may include dividing a pixel array for each of the captured images into a plurality of regions, and selecting, from each of the plurality of regions, one or more pixel locations for evaluating the cost function.

Selecting pixels may also or instead include selecting pixels, and/or the size or shape of the regions from which pixels are selected, based on gradients, strength of local textures, presence of fiducials, or any other suitable metrics, e.g., that measure the amount and type of change within regions or at pixel locations. The local texture may be characterized by how well-defined and distinguishable the texture details are, and the presence of strong local textures can improve the accuracy of a three-dimensional reconstruction from underlying two-dimensional images, and may inherently contain more information concerning misalignment. By contrast, pixel values in regions of weak or poor texture may be poorly differentiated, and can impair reconstruction. Thus, selecting regions and/or pixels associated with strong texture can improve alignment by providing greater signal to a cost function that is used to align images. A number of metrics are known in the art for measuring texture strength, such as entropy, contrast, homogeneity, correlation, gradient, and so forth, any of which may be used to measure texture strength for purposes of selecting regions and/or pixels for use in alignment.

According to the foregoing, registering images may also or instead include selecting a subset of pixel locations in a pixel array for each of the captured images to minimize the cost function, wherein selecting the subset of pixel locations includes selecting at least one of the subset of pixel locations based on a magnitude of the cost function at the one of the subset of pixel locations between the composite image and the sum of the images captured at step 502. In another aspect, registering the images may include selecting a subset of pixel locations based on a metric for strength of texture.

With suitable metrics in place (e.g., initial registration estimate, pixel selection, motion model, cost function), an optimization may be performed that seeks to optimize the cost function by iteratively moving the (non-composite) images relative to one another, summing the images (and scaling where necessary or helpful, e.g., to account for variations in exposure or illumination time among images), and comparing the pixel values for the summed images to the corresponding pixel values for the composite image according to the cost function. It will be appreciated that, while optimization is generally discussed herein as a minimization problem, the nature of the optimization will depend on the nature of the underlying cost function used to perform the optimization. Thus, for example, where the cost function evaluates differences among images (e.g., composite image v. sum of images), then the optimization will be a minimization. However, where the cost function measures similarity, with greater quantitative value assigned to greater image similarity, then the optimization will generally be a maximization of the cost function. Any such technique, or combinations of these techniques, may be used to perform an optimization for registration of images as described herein.

According to the foregoing, in one aspect, the registration may include applying a rigid model to two or more images in order to transform the images relative to one another, while minimizing a cost function that represents a difference between the composite image and a sum of the individual directionally illuminated images from step 502, thereby providing a registration that aligns the images according to the motion model.

In one aspect, the alignment process may also be decomposed into a number of separate alignments of different groups of images. For example, with a three-dimensional reconstruction that uses six different directional illuminations, a first group of three illumination sources may be activated, and a composite image may be captured for those three. Then a second group of illumination sources may be activated, and a second composite image may be captured for those three. Each of these image sets (of three source images) may be registered to a corresponding one of the composite images. Finally, a third composite image may be captured, and this may be used to register the first set of (single illumination) images and the second set of (single illumination images) to one another, e.g., by using a third composite image for a pair of directional illuminations spanning the first group and the second group. Of course, this generally requires the capture of additional composite images for different combinations of directional illumination. However, where the computational complexity of a six-image registration is high, this may achieve overall gains in processing speed, even when accounting for the additional image acquisition and multiple sequential registrations. Furthermore, this may provide increased robustness in motion compensation by providing redundancy among the individual and composite images used for registration. According to the foregoing, registering the images may include aligning a first group of the images to one another in a first image registration, aligning a second group of the images to one another in a second image registration, and registering the first image registration to the second image registration in a third image registration based on an additional composite image captured under illumination conditions including the illumination used for at least one image from the first group and at least one image from the second group.

In another aspect, the registration may include performing an initial gross registration with downsampled images, followed by a fine registration using upscaled parameters from the initial gross registration. This general technique may be performed hierarchically with any number of increasingly low resolution downsampled images. In general, the most efficient number and scale of downsampled registrations may depend on image content, initial resolution, degree of misalignment, and so forth. In one aspect, a predetermined hierarchical strategy may be employed. In another aspect, the number and scale of downsampled representations may be dynamically adjusted based on an initial assessment of image content, e.g., by a human user, machine learning process, or other automated, semi-automated, or manual technique. Thus, in one aspect, registering may include registering downsampled instances of the images captured at step 502, and calculating motion parameters to register the images captured at step 502 by scaling up the motion parameters from the downsampled instances to a full resolution of the images captured at step 502. As noted above, this may also be performed recursively or hierarchically, e.g., where registering includes recursively downsampling pixel data, registering images, and then upsampling motion parameters for an alignment of the downsampled images.

It will be noted that the method 500 is described herein in terms of a registration of each of the single-illumination images to one another. However, this image-to-image registration is generally indirect, and occurs by a process of aligning the individual images, as summed together, to one of the composite images, via an optimization function or the like. Thus, the method 500 may also or instead be described as a registration of the individual images, or groups of images, to a composite image, which then provides an effective coordinate system for inferring alignment of each of the individual images to one another. For purposes of simplicity, this is referred to as registration of the images to one another, which is the desired result for purposes of three-dimensional reconstruction, even where this registration is based on a registration of groups of summed images to one of the composite images, or some other frame of reference.

As shown in step 510, the method 500 may include recovering a three-dimensional shape of the surface based on the aligned or registered images, such as any of the images illuminated under varying conditions as described herein. This may include recovering three-dimensional shape with shape-from-shading, photometric stereo, structured light or any other suitable three-dimensional reconstruction techniques.

In another aspect, the method 500 may include recovering super-resolution images from the registered images. This may be performed independently from the three-dimensional reconstruction, e.g., purely to obtain higher-resolution images of a surface for display or analysis, or this may be performed as a precursor to three-dimensional reconstruction so that the three-dimensional reconstruction can be resolved in greater detail than the source images. Thus in one aspect, recovering a three-dimensional shape of the surface may include obtaining a plurality of super-resolution images of the surface from the registered images, and recovering a super-resolution three-dimensional shape of the surface from the super-resolution images, e.g., using any of the three-dimensional reconstruction techniques described herein. In general, super-resolution processing may include aligning a set of images (e.g., using the techniques described herein), and then merging the images into a higher-resolution image by exploiting residual data or differences between pixel values for aligned/registered frames. This last step may be performed, e.g., using interpolation, back projection, deep learning models such as a convolutional neural network trained on high and low resolution models, or any other techniques known in the art for merging data from two or more images into a single higher-resolution image.

The steps of the method 500 can be repeated as necessary or helpful for a particular imaging or control application. More generally, unless specifically stated otherwise, the various features and techniques described herein may be used alone or in any suitable combination, and may be applied in parallel or sequentially to multiple image sets, without departing from the scope of this disclosure. However, it will also be noted that superposition assumptions may not apply where there is large inter-image displacement. Thus, the rate of acquisition for a series of such images may usefully be constrained in order to maintain, or attempt to maintain, image-to-image movement within predetermined thresholds suitable for a particular imaging system. Other metrics for inter-image motion, such as an initial inertial or image-based motion estimate, may also or instead be used as a threshold or gating criterion for image registration using superposition as described herein.

It will also be understood that, while the method 500 is described with reference to, e.g., a handheld device for capturing shape-from-shading source data, the techniques may also or instead be used in other imaging contexts. For example, in one aspect, the techniques described herein may be used for motion compensation in high-speed robotic tactile sensing applications. In this context, an imaging system may have a camera with an RGB sensor, along with multiple RGB light sources for illumination. As a result, the illuminations may be partially multiplexed in the spectral domain, and also in the time domain. So, for example, when using two sets of RGB light sources, the method 500 may include capturing an image with each light source while the other source is off, and then capturing a third (composite RGB) image with both sets of RGB light sources turned on. The resulting composite image permits precise registration of the two images illuminated from each of the individual RGB light sources using the techniques described herein.

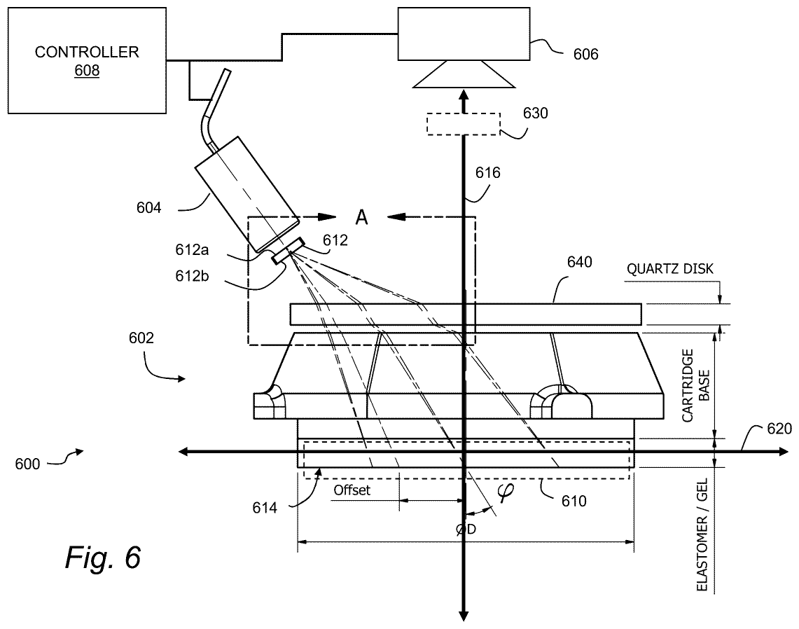

FIG. 6 shows an imaging system 600 with a retrographic sensor 602. The retrographic sensor 602 is illustrated as a removable and replaceable cartridge, however it will be understood that the retrographic sensor 602 may also or instead include any of the retrographic sensors or other elastomeric or conformable optical sensors or the like described herein. The imaging system 600 may also include an illumination system 604, an imaging device 606 such as a camera, processing circuitry 608, and an imaging volume 610. An optical element 612 may be positioned to control illumination of the imaging volume 610 by the illumination system 604. The imaging system 600 may, for example, include a handheld imaging device such as any of those described in Int'l App. No. PCT/US2022/046129, published on Apr. 13, 2023, the entire content of which is hereby incorporated by reference.

The retrographic sensor 602 may be removably and replaceably coupled to the imaging system 600, and may be mechanically keyed or otherwise coupled to the imaging system 600 in a manner that aligns a sensing surface 614 of the retrographic sensor 602 with the imaging volume 610 of the imaging system 600. The retrographic sensor 602 may, for example, include an elastomeric optical element having a soft, optically clear elastomer on a first side facing toward the imaging device 606 and a thin, reflective coating on a second side facing away from the imaging device 606. The retrographic sensor may be configured to deform when placed in contact with a target surface for measurement. More generally, the retrographic sensor 602 may include any deformable element with a reflective coating suitable for image capture as described herein, including sensors using a fluid medium or other deformable medium in place of the elastomer. The imaging system 600 may have an axis 616, such as an imaging axis or an optical axis, that passes through the imaging volume 610. When the retrographic sensor 602 is placed for use in the imaging system 600, the sensing surface 614 of the retrographic sensor 602 may thus intersect the axis 616 of the imaging system 600 and lie within the imaging volume 610 so that the imaging device 606 can capture images of the sensing surface 614 of the retrographic sensor 602 within the imaging volume 610 of the imaging system 600.

The imaging system 600 may include a substrate for the retrographic sensor 602. The substrate may be positioned between the deformable medium and the imaging device 606, and may be formed of a rigid, optically clear material mechanically supporting the deformable medium.

The illumination system 604 may include any light source or combination of light sources suitable for providing illumination through the optical element 612 and into the imaging volume 610, including, e.g., direction light sources and/or structured light sources. When the retrographic sensor 602 is placed for use in the imaging system 600, the illumination system 604 may illuminate the sensing surface 614 of the retrographic sensor 602 and permit capture of images by the imaging device 606. These images may, in turn, be processed by the processing circuitry 608 to resolve three dimensional surface information for an object contacting the sensing surface 614 of the retrographic sensor 602. In one aspect, the illumination system 604 may include a laser or other device that has a coherent, fixed focus and/or that provides collimated illumination. In this context, it will be understood that the fixed focus may include light focused at infinity and collimated or formed of parallel ray traces, as well as light with any other fixed focus that can be used to create the illumination patterns described herein. In another aspect, the illumination system 604 may provide unfocused illumination, with suitable modifications to the optical element 612 and other optical features. The illumination system 604 may also or instead include one or more LED's or other light sources (such as those depicted in FIG. 1) arranged to provide controllable side illumination of the sensing surface 614 within the imaging volume 610, e.g., to support shape-from-shading or similar three-dimensional reconstruction of a target surface.

The imaging device 606 may include a camera or any other combination of optical devices, lenses, filters, and other hardware suitable for capturing images of the reflective surface provided by the sensing surface 614 of the deformable medium for use by the processing circuitry 608 in resolving three-dimensional images. In general, the imaging device 606 may have an imaging or optical axis, such as the axis 616 of the imaging system 600, passing through the imaging volume 610 in order to capture images thereof.

The processing circuitry 608 may include any processor, processing circuitry, controller, microcontroller, or other circuitry, or combination of the foregoing, suitable for controlling operation of the imaging system 600 to acquire three-dimensional information as described herein. In particular, the processing circuitry 608 may be configured to control the imaging device 606 and the illumination system 604 to capture an image of the sensing surface 614 of the deformable medium with the imaging device 606 during different illumination conditions, thereby providing two or more images of the sensing surface 614. The processing circuitry 608 may also be configured to control the imaging device 606 and the illumination system 604 to capture a composite image of the sensing surface 614 while illuminated concurrently under all of the different illumination conditions used to capture the two or more images of the sensing surface 614. The processing circuitry 608 may also or instead include computing resources to perform additional functions described herein. This may include computing resources locally executing on the imaging system 600, other local user resources such as a local desktop computer or workstation coupled to the imaging system 600, or cloud computing resources configured to support image processing using image data from the imaging system 600. By way of non-limiting example, the processing circuitry 608 may include a cloud computing resource configured to register multiple differentially illuminated images to a composite image using optimization of a cost function, as well as to perform a three-dimensional reconstruction using shape-from-shading, photometric stereo, structure light, and the like with the resulting registered images.

The processing circuitry 608 may be configured to register three or more images in a multi-image registration algorithm in which three or more images are registered concurrently, for example, by applying a motion model while minimizing an image difference between the composite image and a sum of the three or more images, thereby providing a registration aligning the three or more images. The processing circuitry 608 may also be configured to recover a three-dimensional shape of the sensing surface using shape-from-shading or other techniques based on the three or more images, as aligned according to the registration.

In one aspect, the processing circuitry 608 may be configured to control the imaging system 600 to obtain images under different illumination conditions. The processing circuitry 608 may also or instead be configured to illumination multiplex and/or demultiplex groups of images and composite images captured under various combinations of directional illumination in order to obtain surface normal values from the sensing surface 614 at a greater resolution than a nominal resolution of the imaging device 606 (e.g., at super resolution). In this context, super resolution imaging will be understood to include any imaging resolution greater than limits imposed by an optical system (e.g., by hardware pixels or other hardware or software limits) that constrain the resolution of acquired images to a nominal resolution less than the super resolution obtained with the multiple images. For example, where a camera has a predetermined resolution, a super resolution image may contain a greater number of pixels—either in total, or per unit of imaging area—than the predetermined or nominal resolution of the camera. The processing circuitry 608 may also or instead illumination multiplex and/or illumination demultiplex a set of images to reduce pixel noise in the three or more images.

In one aspect, the processing circuitry 608 that is physically coupled to the imaging system 600 may provide limited control of data acquisition, e.g., to acquire data for transmission to a separate processor for processing, with the image data transmitted to other processing resources for other pre-processing and three-dimensional reconstruction. In another aspect, the processing circuitry 608 may include one or more microprocessors, field programmable gate arrays, graphics processing units, and/or other processors to locally process images and resolve image data into three-dimensional data for a surface within the imaging volume 610. In one aspect, the processing circuitry 608 may include a processor configured by instructions stored in a memory to receive an image from the imaging device 606 of patterned light created by the optical element 612 and reflected by the thin, reflective coating of an elastomeric optical element or other sensing surface as it deforms to a target surface of an object within the imaging volume 610. This processor, or another processor integrated into the imaging system 600 or coupled in a communicating relationship with the imaging system 600 may be further configured by instructions stored in a memory to calculate a quantitative surface topography of the surface based on the images captured by the imaging device 606.

The imaged surface in these reconstructions may include, e.g., a deformable surface of an elastomeric optical element intersecting the imaging volume 610 and configured to conform to a target surface of an object to be measured. As a target surface intersects the imaging volume 610, an image of the deformable surface, e.g., the sensing surface 614 of the retrographic sensor 602, that is captured by the imaging device 606 may be used to infer the three-dimensional shape of the target surface. The processing circuitry 608 may be configured to control the imaging device 606 and the illumination system 604 to illuminate the deformable surface under varying conditions while capturing images. In one aspect, the processing circuitry 608 includes a cloud computing resource configured to receive the three or more images and the composite image, to register the three or more images based on a registration of a sum of the images to the composite image, and to recover the three-dimensional shape of the sensing surface using shape-from-shading or other techniques based on the registered images.

The illumination system 604 can be configured to independently illuminate the sensing surface 614 through the deformable medium of the retrographic sensor 602 from multiple directions, or using other forms of differential illumination based on, e.g., structured light or different wavelengths. For directional illumination, the sensing surface 614 can be illuminated independently from each of three or more directions about the axis 616 (which may include or be parallel to an optical axis) of the imaging device 606, thereby providing directional illumination of the sensing surface 614. For structured light, the sensing surface 614 can be illuminated independently with three or more different patterns.

The imaging volume 610 may generally define a three-dimensional field of view for the imaging device 606. As described above, the imaging device 606 may have an imaging axis, such as the axis 616 of the imaging system 600, that passes through the imaging volume 610. A plane may intersect the imaging volume 610 and lie substantially perpendicular to the imaging axis of the imaging device 606. This plane also lies substantially perpendicular to the plane of FIG. 6, and is illustrated as a line 620 where the plane intersects the plane of FIG. 6, and where the plane intersects the imaging volume 610 depicted therein.

The optical element 612 may include diffraction gratings, lenses, filters, microtextured surfaces, metasurfaces, and the like, suitable for creating a desired illumination direction and/or pattern within the imaging volume 610. In general, a pattern may include a plurality of features such as dots (including random dots and/or ordered dots), lines, sinusoidal patterns (e.g., with predetermined spatial frequencies), polygons, or the like, as well as combinations of these, that can be projected onto the sensing surface 614 within the imaging volume 610 and imaged by the imaging device 606. In one aspect, the pattern may include a first plurality of features closely spaced within the plane (represented by line 620) and a second plurality of features visually distinguishable from the first plurality of features and more distantly spaced within the plane. In this pattern, the more distantly spaced features may provide fiducials or other high-texture landmarks within the imaging volume 610 to assist in registration and other processing, while the more closely spaced features support extraction of three-dimensional information with a higher resolution that is more sensitive to surface topography. The pattern may also or instead include a first plurality of features and a second plurality of features collectively forming a regular geometric pattern within the plane, with the second plurality of features forming visually distinguishable anchor points or fiducials within the pattern.

The anchor points or landmarks may be spaced sufficiently far apart so that they are unlikely to intersect (or they are physically unable to intersect) within the imaging plane due to deflection along the axis 616. In these embodiments, the pattern may generally include a first plurality of features closely spaced to provide high resolution detection of depth within the imaging volume and a second plurality of features placed sufficiently far apart within the plane through the imaging volume 610 to avoid intersections along the imaging axis (e.g., axis 616) within the imaging volume 610 during a maximum expected deformation of the sensing surface 614 of the retrographic sensor 602 within the imaging volume 610. By positioning the second plurality of features in this manner, the features can remain unambiguously directionally associated with motion within a two-dimensional imaging field over the full range of expected deformation. It will be understood that in this context, the expected deformation may include z-axis displacement, as well as any x-axis or y-axis displacement resulting from sheering, wrinkling, and the like of the elastomeric optical element as the imaging system 600 is placed against a target surface and manipulated by a user.

In one aspect, the optical element 612 may include a diffractive optical element positioned to receive the illumination from the illumination system 604 (e.g., a coherent light source such as a laser) on a first surface 612a (e.g., a surface facing the illumination system 604) and create a three-dimensional illumination pattern within the imaging volume 610 from a second surface 612b opposing the first surface 612a. Where a diffractive optical element is used, the diffractive optical element may include micropatterned structures, e.g., on either or both of the first surface 612a and the second surface 612b, optionally along with additional lenses, that cooperate to create the desired illumination pattern when a suitable light source is directed toward the first surface 612a. A variety of types of diffractive optical elements are known in the art, and may be used to create illumination patterns that vary in intensity in a far-field plane, and that vary in intensity and/or focus along an imaging axis. As a significant advantage, these properties may be exploited to create a three-dimensional illumination pattern within the imaging volume 610 of an imaging system 600 to facilitate resolution of three-dimensional information from the sensing surface 614 of the retrographic sensor 602. More specifically, a diffractive optical element may be used to create illumination patterns with complex three-dimensional structures, e.g., that are not simple two-dimensional projections that scale linearly with distance. These patterns can usefully encode distance within an imaging volume in a manner that can facilitate shape recovery from single images. Any number of additional optical components may also or instead be included to create illumination patterns as described herein. For example, the optical system may incorporate light shaping features such as lenses, filters, and the like, e.g., to control optical power, compensate for distortions or wavefront errors, and so forth.

Furthermore, while suitable Diffractive Optical Elements (DOEs) may be configured, e.g., with micro-patterned and/or nano-patterned structures on various optical surfaces of a discrete optical element as illustrated in FIG. 6, the DOE may also or instead be implemented in other physical locations and/or in other optical components within the optical path for illumination, e.g., with micro-patterning of the sidewall, top, and/or bottom of the retrographic sensor 602 substrate, and/or within other optical elements of the system.

In this context, a three-dimensional illumination pattern may include any three-dimensional shape, pattern, or structure that varies with depth or distance from the optical element 612. For example, a three-dimensional illumination pattern may include diverging illumination projections such as a grid, point array, cone, or pyramid pattern that diverges (e.g., becomes larger in an imaging plane) as distance from the optical element 612 increases, or more generally, a three-dimensional pattern varying along the imaging axis (e.g., the axis 616) within the imaging volume 610. In another aspect, the three-dimensional illumination pattern may include a pattern with one or more features that vary along a line of projection from the optical element 612. For example, a circle, dot, or other image may change in intensity or focus (with or without a change in size) as a distance of the projected image from the optical element 612 increases. These geometric characteristics of the three-dimensional illumination pattern may usefully be created by a diffractive optical element and used to improve accuracy of three- dimensional data based on images of the sensing surface 614 captured by the imaging device 606. In one aspect, these and/or other illumination techniques described herein may be used to create fiducials for aligning multiple images, e.g., to provide a basis for an initial estimate of motion parameters for a motion model used to register the images.

In one aspect, the optical element 612 may be positioned to create a pattern within the imaging volume 610 from a surface at an oblique angle to the plane intersecting the imaging volume 610, such as an angle of at least thirty degrees, at least forty-five degrees, at least sixty degrees, about sixty degrees, or between fifty and seventy degrees. It will be understood that ray traces from the optical element 612 may change angles multiple times as the light from the optical element 612 is optically coupled to the sensing surface 614. For example, the light may travel through surfaces of a quartz sheet 640 such as a quartz disk or the like used to protect/seal an interior of the imaging system 600 from the exterior environment where the retrographic sensor 602 is removably coupled to a body of the retrographic sensor 602. In this context, unless stated otherwise, the angle of interest is the angle at which these ray traces intersect the plane (identified by the line 620) and/or the sensing surface 614, which is where the illumination meets the deformable surface of the retrographic sensor 602 and where image data is captured for resolving three-dimensional shape.

It will be appreciated that while a plane intersecting the imaging volume 610 provides a useful frame of reference for discussing other features and structures of the imaging system 600, in one aspect, the imaging volume 610 may be bounded by curved surfaces, e.g., where the retrographic sensor 602 is pre-shaped for measuring spherical, cylindrical, or other concave or convex surfaces, or more generally, for measuring any other target surfaces having a characteristic shape that is known and non-planar. In such cases, a single plane may omit significant extents of the imaging volume 610. A plane of interest may nonetheless be selected, such as a plane normal to an optical axis of an imaging device used to capture images of the imaging volume 610, or a plane normal to an axis of a lens used to focus an image from the imaging volume 610, or a plane tangent to a contact region of the target surface, or a plane otherwise oriented to provide a frame of reference for describing angles of illumination, imaging, contact, and so forth.

In many illumination patterns, steeper incident angles (e.g., more acute angles relative to the plane) can provide greater sensitivity to three-dimensional displacement. As such, where side illumination is provided as depicted in FIG. 6, it may be advantageous to include one or more additional light sources and/or optical elements in the illumination system 604 to provide illumination from different directions around the axis 616 of the imaging system 600 so that different regions of the imaging volume 610 can benefit from steep side illumination. In one aspect, these additional light sources may also use different spectral bands so that different patterns can be captured simultaneously, e.g., in a single image frame, where visual features can be associated with specific light sources and DOEs (or other optical elements) based on wavelength. This approach can also advantageously improve sensing of occluded areas and/or steep or sharp surface features of a surface. Thus, in one aspect, three-dimensional data for different portions of the sensing surface 614 may be calculated using illumination from different light sources and/or optical elements. Any such groups of images may be registered as described herein provided they can be summed and referenced to a composite image acquired under corresponding combination of concurrent illumination conditions.

In another aspect, different illumination sources may be multiplexed, e.g., by using light of different wavelength ranges (or different specific wavelengths) to illuminate the imaging volume 610 from different directions, and by separately processing the images from these different wavelength ranges so that multiple images from multiple illumination directions can be concurrently captured and/or processed. According to the foregoing, the imaging system 600 may usefully include a second diffractive optical element positioned and structured to create a second pattern within the imaging volume 610 for a different location about a perimeter of the imaging volume than the first diffractive optical element. These multiple images that are illuminated with different patterns may also be registered to one another or otherwise combined using the techniques described herein. More generally, two or more additional light sources and/or optical elements may be incorporated into the imaging system 600 to improve imaging under various imaging conditions and/or imaging of various surface topographies.

In another aspect, additional imaging techniques may be incorporated into the imaging system 600, e.g., to improve accuracy and robustness of the imaging system 600, e.g., to support higher-speed, lower-resolution processing for certain imaging contexts (image previews, sparse three-dimensional processing, etc.) or for other reasons. Thus, in one aspect, the imaging system 600 may include a multi-view imaging system that uses multiple imaging techniques (e.g., a stereoscopic imaging system, photometric stereo system, or the like), each configured to calculate a quantitative surface topography of a surface within the imaging volume 610 based on images of the surface from two or more different perspectives, and/or using different images and/or processing techniques for three-dimensional reconstruction. In this context, a multi-view imaging system may include a stereoscopic imaging system, a photometric stereo system, a wavelength multiplexed imaging system (based on, e.g., visible and infrared, fluorescence, etc.), and so forth. In another aspect, a gradient-based system may use unfocused illumination from various directions to resolve three-dimensional surface information. In general, these alternative imaging modalities may be optically multiplexed or otherwise combined for concurrent operation with the system described above. For example, these alternative systems may resolve a three-dimensional shape of the surface using light from a second light source in a second spectral band having wavelengths non-overlapping with a first spectral band of the illumination system 604 and/or one or more other light sources used by the imaging system 600. The imaging system 600 may also or instead employ confocal three-dimensional imaging to reject out-of-focus light and incrementally capture images at two-dimensional slices passing through the imaging volume. These individual slices of an in-focus surface can then be combined into a three-dimensional reconstruction.

More generally, any of a variety of complementary imaging modes may be used to support imaging of different surface types, imaging at different speeds, imaging with different resolutions, imaging over different depth ranges, and so forth. For example, these complementary techniques may be used in combination to support improved measurement of low spatial frequency three-dimensional features such as macroscopic, large-scale features of a target surface that are preferably removed before measuring micron scale surface features with gradient-based depth calculations or the like. Furthermore, these depth measurements can provide information on the amount of elastomer compression within an imaging gel, provide real-time guidance and user feedback for optimal compression, support higher-speed rendering (e.g., using a sparser data array), support measurements of high frequency force (e.g., using a finite element model of the elastomer), and so forth.

In one aspect, the imaging system 600 may include a supplemental depth measurement mode for measuring a distance to a target surface, e.g., to estimate a compression of an elastomeric imaging medium such as any of the elastomeric optical elements described herein, and to provide feedback to a user guiding the user to an optimal range of contact forces. This may, for example, include user feedback via a number of LEDs or the like on a handheld imaging device, an auditory output device, or a display in a user interface for the device, e.g., on a computer or the like coupled to the handheld device, which may be configured to guide the user with visual or other feedback to an optimal position, orientation, and/or contact force while positioning a handheld scanner.

In one aspect, the imaging system 600 may include a lens 630 for variably focusing the imaging device 606 on a surface within the imaging volume 610. For example, the lens 630 may be a liquid lens that uses a combination of optical fluids and a polymer membrane to change focus by changing shape, or any other adaptive lens or the like. A liquid lens advantageously provides a compact mechanism for controlling focus without mechanical, moving parts and without physically moving a lens along the imaging axis to change focusing distance. However, other lenses may also or instead be used to control focus of illumination and/or imaging with the imaging device 606 at various depths or z-axis positions through the imaging volume 610 and along the imaging axis, and may be adapted for use in an imaging system 600 as described herein.

In one aspect, the lens 630 may include a lens system focused with a piezo- focus drive, a voice coil motor, or any other electromechanical actuator(s) suitable for z-stack image acquisition. For example, the lens 630 may include one or more high-resolution lenses with narrow depth-of-field. In order to avoid lowpass filtering that might otherwise be imposed by a locally out-of-focus lens, the lens 630 can be variably focused to scan through a range of depths (e.g., along the z-axis or imaging axis) to provide partial, locally focused images at each desired depth. This stack of images can be assembled into a single image with greater depth-of-field for subsequent three-dimensional processing, e.g., with photometric stereo, or to directly measure quantitative depth information by finding the best focus among various focal depths for local regions within the imaged field. This single image with improved depth-of-field can also facilitate recovery of texture or the like, and may be combined with other imaging modalities (such as photometric stereo) to provide more accurate and higher resolution surface measurements across an imaging field without distortion artifacts.

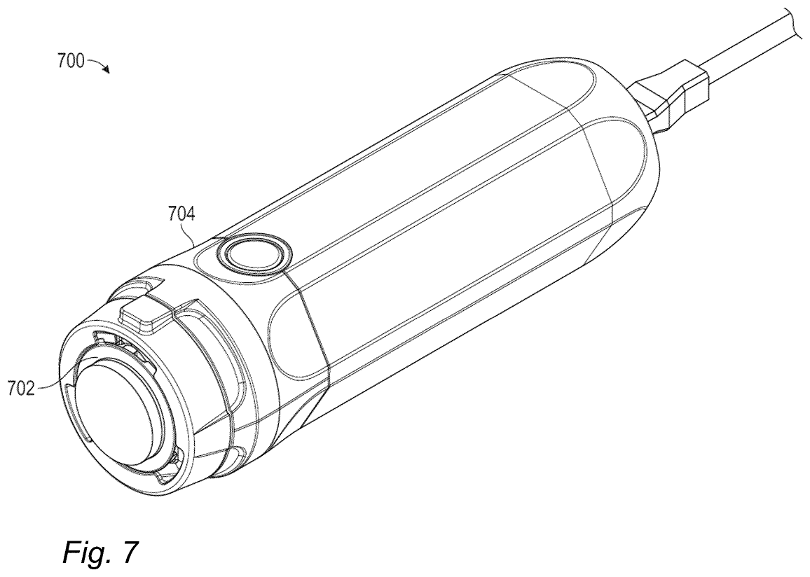

FIG. 7 shows an imaging system 700. The imaging system 700 may be a handheld imaging system, and may include a retrographic sensor 702 in a cartridge that can be removed from and replaced to a housing 704 of the imaging system 700. In general, a handheld imaging system may be prone to user handshake that can affect imaging resolution, particularly where image capture times are long (e.g., 15-50 milliseconds per frame for 7+frames) and resolution is high (e.g., less than twenty microns, or less than two or three microns). In these cases, multiple images may usefully be aligned to one another as described herein before performing a three-dimensional reconstruction based on the multiple images.

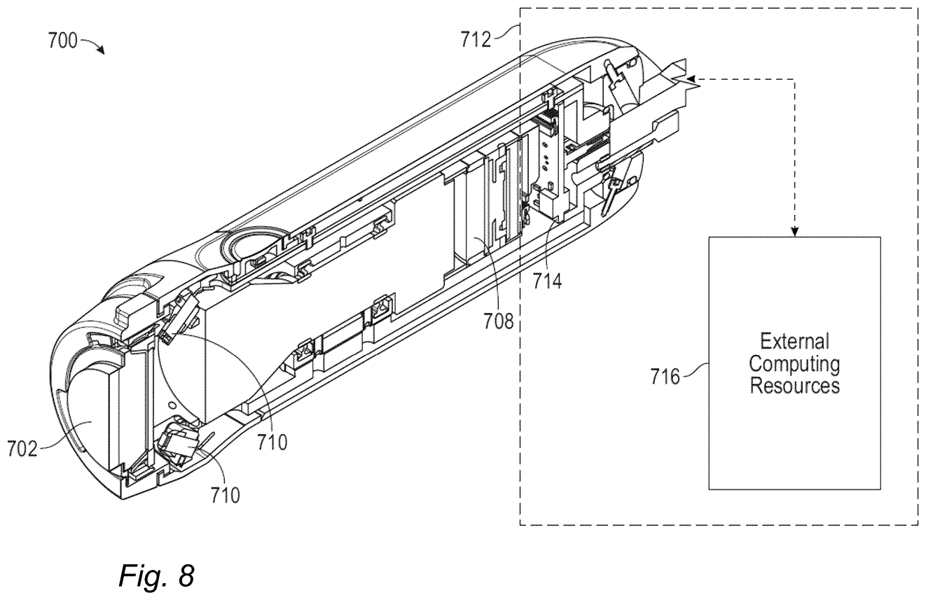

FIG. 8 shows a cut away view of the imaging system 700 of FIG. 7. In general, the imaging system 700 may include features of any of the imaging systems described herein, such as a retrographic sensor 702, a camera 708, an illumination system 710, and processing circuitry 712.

The retrographic sensor 702 may include any of the retrographic sensors or other sensing elements or the like described herein. In one aspect, the retrographic sensor 702 includes a deformable medium such as an optically clear, deformable material, along with a sensing surface covering a portion of the deformable medium and providing a reflective surface visible through a second surface of the deformable medium. The retrographic sensor 702 may be configured as a cartridge for removable and replaceable use with the imaging system 700. As further described herein, the retrographic sensor 702 may have a substrate, with the deformable medium disposed on the substrate and the substrate positioned between the deformable medium and the camera 708. The substrate may generally be formed of a rigid, optically clear material suitable for mechanically supporting the deformable medium.

The camera 708 may be any camera, group of cameras, or other imaging systems, optical sensors, or the like suitable for acquiring images for use in three-dimensional reconstruction as described herein. In general, the camera 708 may be positioned to capture images of the reflective surface of the retrographic sensor 702 through the second surface of the deformable medium.

The illumination system 710 may include any light source or combination of light sources suitable for differential illumination of the sensing region of the retrographic sensor 702, such as directional illumination, patterned illumination, differential wavelength illumination, and so forth. The illumination system 710 may, for example, include one or more light emitting diodes, lasers, electroluminescent light sources, and the like, along with related lenses, filters, and other optical elements for focusing and directing illumination from the light source(s) for illumination as generally described herein. In general, the illumination system 710 may be configured to independently illuminate the sensing surface through the deformable medium from each of three or more directions about an optical axis of the camera, or otherwise provide differential illumination of the sensing surface as described herein.

The processing circuitry 712 may include local computing resources 714 such as a controller, microcontroller, processor, or other circuitry inside the imaging system 700, e.g., to control operation of the imaging system 700. The processing circuitry 712 may also or instead include remote computing resources 716 external to the imaging system 700, such as a desktop computer or the like locally coupled to the imaging system 700, or a virtualized or cloud computing resource remotely coupled to the housing 704 and used to process images from the imaging system 700 for three-dimensional reconstruction.

The processing circuitry 712 may be configured, e.g., by computer executable code stored on the imaging system 700 and executable by the local computing resources 714, to control the camera 708 and the illumination system 710 to capture an image of the sensing surface of the retrographic sensor with the camera 708 during a differential illumination of the sensing surface, e.g., individually from each of the three or more directions, thereby providing three or more images of the sensing surface. The processing circuitry 712 may also be configured to capture a composite image of the sensing surface while illuminated concurrently under all of the differential illumination conditions (e.g., three or more different directions, or any other differential illumination conditions).

As noted above, the processing circuitry 712 may also include a cloud computing resource, which may be configured, e.g., by computer executable code stored on the remote computing resources 716, to register the three or more images by applying a motion model while minimizing an image difference between the composite image and a sum of the three or more images, thereby providing a registration aligning the three or more images. It will be understood that two images may also or instead be used, however, the use of three images can reduce or avoid spatial ambiguity in all directions within the imaging plane. The processing circuitry 712 may also be configured to recover a three-dimensional shape of the sensing surface using shape-from-shading, or any other suitable three-dimensional reconstruction technique or combination of techniques based on the registered images. In one aspect, the remote computing resources 716 may be configured to receive the three or more images and the composite image from the imaging system 700, to register the three or more images (e.g., using any of the techniques described herein), and to recover the three-dimensional shape of the sensing surface using shape-from-shading. Where helpful for additional processing, motion parameters for the registration that aligns the three or more images to one another may also or instead be used.

It will be noted that the terms alignment and registration are used frequently herein. These terms, while closely related, have slightly different meaning in the field of image processing. Registration is generally the process of transforming different sets of data into one coordinate system. By contrast, alignment generally refers to the lining up of features in two or more images to a common coordinate system, e.g., by applying transformations such as translations or rotations to perform localized adjustments. Formally, alignment may be viewed as a subset of registration, where the transformations are usually assumed to be minor and the overall complexity of the task is lower. However, these terms are generally used interchangeably herein to refer to the transformation of two images into a common, aligned, coordinate system, e.g., to facilitate direct pixel-by-pixel comparison, unless a different meaning is specifically provided, or otherwise clear from the context.

In one aspect, multiplexed illumination may be used in this context to improve resolution, reduce pixel noise, and so forth. In general, multiplexed illumination is a technique used in various imaging and optical systems to improve the quality of captured images, increase the speed of data acquisition, or enable the extraction of additional information from the scene. In the present context, time-multiplexed illumination may be used with a series of time-separated images, e.g., where a surface of interest is illuminated sequentially with different patterns or from different directions, and a camera captures the resulting images in synchronization with the illumination system. More specifically, by acquiring different combinations of composite and individual illumination, this approach advantageously permits improved image resolution and noise reduction. Thus, for example, the processing circuitry 712 may be configured to obtain one or more additional images under different illumination conditions, and to illumination demultiplex the three or more images, the composite image, and the one or more additional images to refine image registration and obtain surface normal values from the sensing surface at a greater resolution than a nominal resolution of the camera. In another aspect, the processing circuitry 712 may be configured to obtain one or more additional images under different illumination conditions and to illumination demultiplex the three or more images, the composite image, and the one or more additional images to reduce pixel noise (e.g., due to unwanted motion) in the three or more images and the composite image.

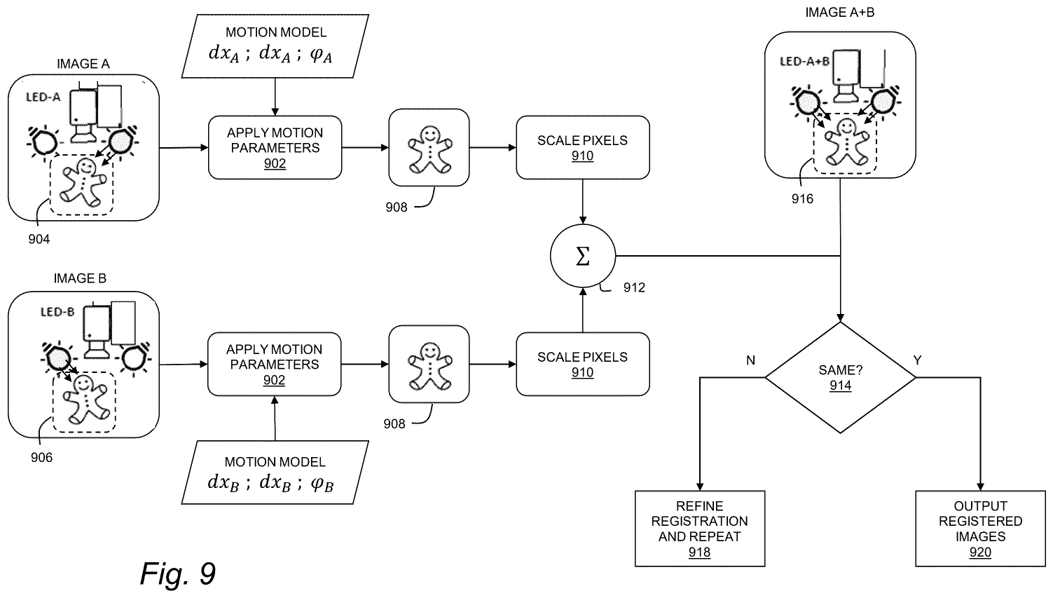

FIG. 9 illustrates a motion compensation technique. As illustrated, a first image (Image “A”) and a second image (Image “B”) are captured, each with its own dedicated directional illumination or other differential illumination. When these two images are recorded at different times, there may be misalignment between the images due to camera motion. In order to address this potential misalignment, an image motion model may be selected, along with corresponding motion parameters that can be variably applied to the images to realign them to a common coordinate system. For example, a rigid motion model with two degrees of translational freedom (x and y) and one degree of rotational freedom (φ) may be represented in a similarity motion model as follows:

$$\begin{matrix}{x}_{i} = Hx \\ H = [ \begin{matrix}cos ( φ ) & sin ( φ ) & dx \\ - sin ( φ ) & cos ( φ ) & dy \\ 0 & 0 & 1\end{matrix} ]\end{matrix}$$

where the motion parameters dx, dy, and φ are used to characterize the motion due to camera movement. The three parameters dx, dy, and φ usefully capture expected movements for a handheld scanner such as any of those described herein. In this case, the camera is primarily perpendicular to the imaged surface, e.g., when using a tactile sensor with a thin deformable medium disposed over a large surface area (relative to the thickness of the deformable medium), and camera angle rotation and z displacement will typically make relatively small contributions to image motion. These motion constraints permit a reduction in the number of degrees of freedom required for an effective motion model and provide a corresponding reduction in computational complexity. However, it will be understood that a variety of other motion models may also or instead be used. For example, this may include models using different or additional rotational or translational parameters. In another aspect, a motion model may include a deformable motion model, e.g., for imaging applications where there might be strong local motion independent of camera movement.

In general, the motion parameters may be iteratively estimated and applied (step 902 to differential images such as a first image 904 (labelled “IMAGE A”) and a second image 906 (labelled “IMAGE B”) to obtain registered images 908 that attempt to compensate for intra-image camera motion. The pixels may then be scaled (step 910) to account for differences in exposure and/or illumination time, and the corrected images may then be summed (step 912) and compared (step 914) to a third image 916 (labelled “IMAGE A+B”) that was captured as a composite image under each of the differential illumination conditions concurrently.

Standard optimization techniques may then be used to evaluate the success or failure of a realignment (step 918) based on the current motion parameters. For example, a cost function or the like may be used to evaluate the current motion parameters, and the realignment and evaluation may be repeated until a satisfactory result is achieved, as shown in step 920, where the registered images may be output, optionally with the accompanying alignment data. The optimization may include the minimization or maximization of a cost function, such as any of the cost functions described herein. The optimization may also or instead use an exit condition such as a convergence in a value of the cost function to within some threshold over some number or range of motion parameter adjustments. More generally, the optimization may use any condition or group of conditions suitable for evaluating whether a number of images have been successfully realigned based on the source images, a motion model, motion parameters, and the cost function, and/or whether no further improvement can be achieved (or alternatively, when no alignment can be achieved).

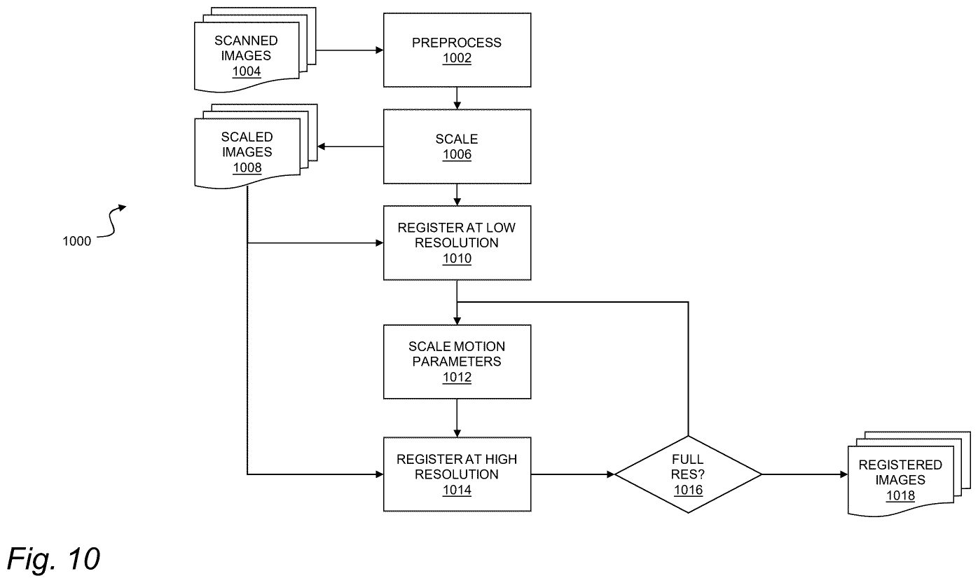

FIG. 10 is a flowchart of a motion compensation method. In particular, a hierarchical technique is illustrated for scaling registration. This may include scaling a collection of differentially illuminated images to a lower resolution representation, registering the lower resolution images using the techniques described herein, and then scaling the resulting motion parameters to a higher resolution as an initial registration for the high resolution images.

This technique may be applied hierarchically by downsampling the images into a number of increasingly low resolution image sets, and then progressively upsampling the registration parameters to higher resolution image sets to eventually provide a highly accurate initial estimate for the full resolution images. Thus a method 1000 may include reducing image motion range by formulating the image motion parameter estimation as a hierarchical problem where initial parameters are estimated on downsampled images. The motion parameters identified for alignment of a downsampled image set using, e.g., the optimization techniques described herein, may then be upsampled to provide initial motion estimates for image alignment at the next higher resolution level.

As shown in step 1002, the method 1000 may include filtering or otherwise preprocessing scanned images 1004, such as any of the differentially illuminated images described herein. In one aspect, this may include applying a Gaussian spatial filter to each image in order to smooth the images and reduce noise. While the parameters of the Gaussian spatial filter may vary depending on the imaging context, in one practical use, a Gaussian spatial filter with a standard deviation of three, or about three, was demonstrated to suitably reduce the influence of random pixel noise without loss of three-dimensional accuracy. It will be appreciated that other filters or techniques may also or instead be used to preprocess images for hierarchical registration as described herein. It will also be understood that filters may also usefully be employed with motion compensation as described herein, even where hierarchical registration is not being used.

As shown in step 1006, the method 1000 may include scaling the images, e.g., by downsampling the image set into image sets of progressively lower resolution. For example, this may include downsampling the images to a scale of 0.1, or about one tenth, and 0.55, or about one half. These image sets may be stored, along with the preprocessed full resolution images as scaled images 1008 for further processing.

As shown in step 1010, the method 1000 may include registering a lowest resolution set of the scaled images 1008 (including a low resolution composite image) to one another using the techniques described herein. For the lowest resolution images, an initial registration estimate may be provided using any of the techniques described herein. This pre-alignment step may, for example, include a brute force estimation of the image similarity or difference at a number of pre-selected motion parameters, or the use of initial motion parameter estimates based on an independent source such as an inertial measurement unit or other motion sensor for a camera, or any of the other sources of an initial estimate described herein. Registering the images may include generating a set of motion parameters that characterize motion between two or more of the images so that they can be aligned or registered to one another when performing, e.g., a three-dimensional reconstruction or other processing.

As shown in step 1012, the method 1000 may include scaling the motion parameters from the lowest resolution images so that they correspond to the scale of the next higher resolution set of images in the scaled images 1008. For example, for progressive scales (relative to full resolution) of 0.1 and 0.55, this may include multiplying x and y displacement parameters by 5.5.

As shown in step 1014, the method 1000 may include registering the scaled images 1008 at the next higher resolution. In general, the scaled motion parameters from the low resolution registration may be used as an initial estimate for registration at this next higher resolution. With the scaled images and scaled motion parameters, registration may then be performed using the differentially illuminated images and the composite image as more generally described herein.

As shown in step 1016, the method 1000 may include determining whether there are additional hierarchical layers of resolution for processing. If the currently registered images from the scaled images 1008 are full resolution images (e.g., relative to the scanned images 1004, or some other target resolution of interest based on the scanned images), then the method 1000 may proceed to step 1018 where registered images, optionally along with any motion parameters, residual error data, and/or other information of interest may be stored for use, e.g., in three-dimensional reconstruction, super-resolution imaging, or other processes as described herein. If the currently registered images are not full resolution, then the method 1000 may return to step 1012 where motion parameters can be scaled (upsampled) to the next higher resolution, and an additional registration can be performed in the higher resolution space. This may be repeated until a full resolution (e.g., scale=1) or other target resolution is reached.

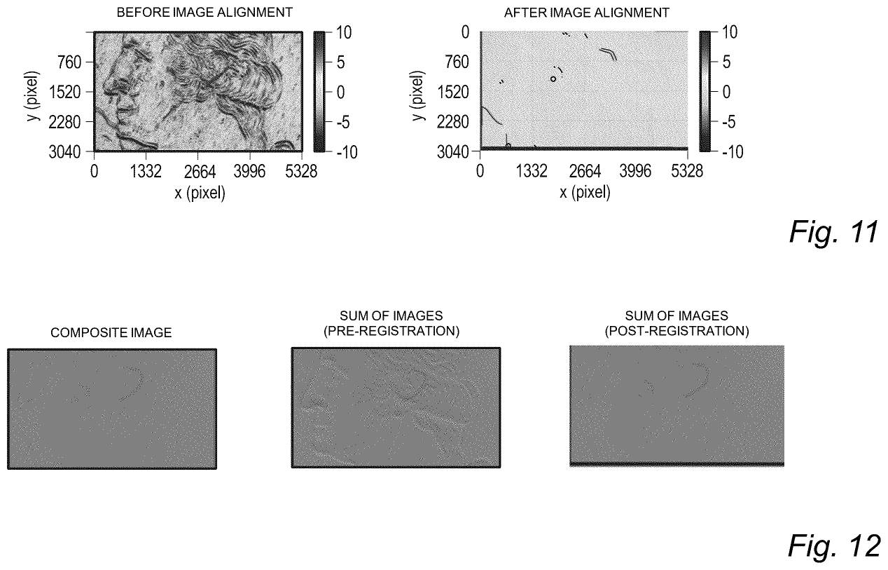

FIG. 11 illustrates a sum of images before and after alignment. The image on the left shows a difference, on a pixel-by-pixel basis, between (a) a composite image and (b) the sum of single illumination images before alignment. As expected, motion artifacts between the time-separated single illumination images results in a sum of pixel values that differs significantly from the composite illumination image, resulting in significant residual error, particularly around areas of significant local height change. The image on the right shows a second difference, on a pixel-by-pixel basis. In particular, the image on the right shows a difference, on a pixel-by-pixel basis, between (a) the composite image and (b) the sum of single illumination images after alignment using the techniques described herein. Because the motion artifacts have been reduced, the sum of single illumination images very nearly matches the composite illumination image, leaving much less difference across the field of view.

In one aspect, the large local image differences in the left-hand image (indicated by dark shades) can provide useful indicia of the magnitude and direction of misalignment. The motion compensation techniques described herein may use the pixels in these high cost or high texture regions to provide an initial estimate of motion parameters for misalignment. These areas of large local difference may also or instead suggest advantageous pixel or region selections for performing iterative optimizations. Thus in one aspect, the selection of pixels for performing optimization calculations may include selecting pixels for optimization based on local differences between the composite image and the pre-registration summed images, which may be evaluated, e.g., based on a value of the optimization cost function, the intensity, or some other estimator or function at each pixel location for the pre-registration sum of images.

FIG. 12 illustrates a comparison of a composite image to a summed image before alignment (pre-registration) and a summed image after alignment (post-registration). The composite image shows a target surface illuminated concurrently under all differential illumination conditions-in this case while illuminated from three different directions. This composite image provides a quantitative target for registration of the individual illumination images. The pre-registration sum of images is derived by summing pixel values for each pixel location in each of the individual illumination images before any registration or alignment has been performed. As in FIG. 11 above, this pre-registration image contains substantial motion- based artifacts, particularly in areas of high texture or high local differences. By optimizing a cost function to identify motion parameters that minimize motion-based artifacts, the individual images may be registered to one another as described herein. The resulting post-registration sum of images is illustrated in FIG. 12, and can be seen to visibly converging on the composite image that provides a target for alignment.

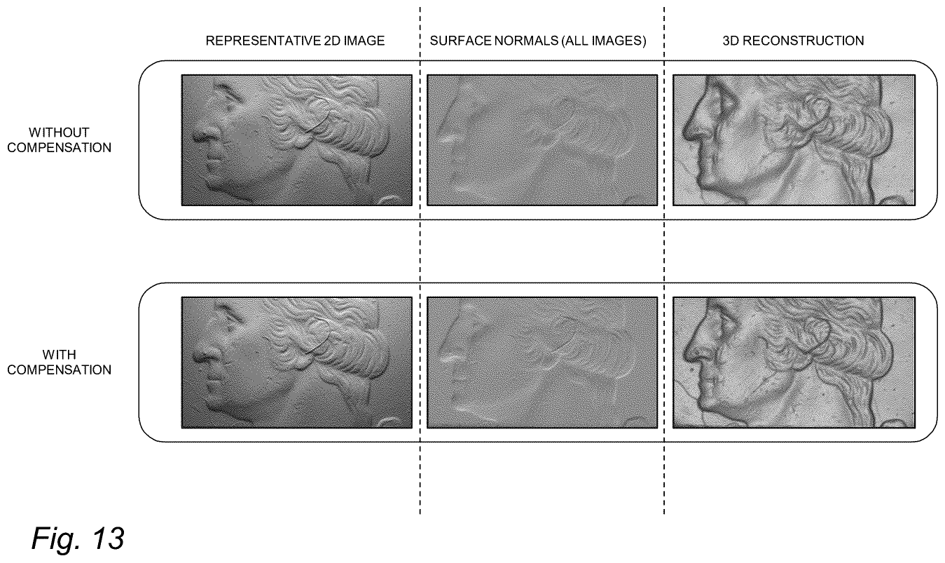

FIG. 13 illustrates a surface normal map and rendered three-dimensional surface with and without motion compensation. The images in FIG. 13 were captured using a commercially available GelSight retrographic sensor. The first column illustrates a representative two-dimensional image under differential illumination (in this case, directional illumination). The second column illustrates a surface normal map derived from a set of images obtained under multiple differentially illuminated images. The calculated surface normal map without compensation can be seen to include a reduced sharpness or focus, resulting from an accumulation of motion artifacts across the imaged surface. The three-dimensional reconstruction, with compensation as shown in the bottom row, contains visibly improved detail when compared to the three-dimensional reconstruction without compensation. Both the surface normal map image and the three-dimensional rendered surface contain visibly smaller scale geometries and a resulting, sharper image when motion compensation is applied.

The above systems, devices, methods, processes, and the like may be realized in hardware, software, or any combination of these suitable for a particular application. The hardware may include a general-purpose computer and/or dedicated computing device. This may include realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X may include any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Thus, while particular embodiments have been shown and described, it will be apparent to those skilled in the art that various changes and modifications in form and details may be made therein without departing from the spirit and scope of this disclosure and are intended to form a part of the invention as defined by the following claims.

What is claimed is:

1. A computer program product comprising computer executable code embodied in a non- transitory computer readable medium that, when executing on one or more computing devices, causes the one or more computing devices to perform the steps of:
capturing three images including:
a first image of a surface while illuminating the surface from a first direction,
a second image of the surface while illuminating the surface from a second direction, and
a third image of the surface while illuminating the surface concurrently from the first direction and the second direction; and
registering the first image to the second image by applying a motion model to at least one of the first image and the second image relative to the third image while minimizing a cost function representing a difference between:
the third image, and
a sum of the first image and the second image,
thereby providing a registration aligning the first image to the second image according to the motion model.

2. The computer program product of claim 1, wherein the cost function is based on differences in pixel values.

3. The computer program product of claim 1, wherein the cost function is evaluated for a subset of pixels.

4. The computer program product of claim 1, wherein the cost function is based on an image similarity metric.

5. The computer program product of claim 1, wherein the cost function is based on a normalized cross-correlation coefficient.

6. The computer program product of claim 1, further comprising code that causes the one or more computing devices to perform the step of recovering a three-dimensional shape of the surface with shape-from-shading based on the first image and the second image, as aligned according to the registration.

7. The computer program product of claim 1, wherein minimizing the cost function includes minimizing a difference between pixel values at one or more pixel locations in a first pixel array for the third image and the sum of the first image and the second image at one or more corresponding locations. 8 The computer program product of claim 1, wherein the motion model includes a rigid motion model.

9. The computer program product of claim 8, wherein the rigid motion model includes one or more of a rigid rotation and a rigid translation.

10. The computer program product of claim 1, wherein the motion model includes a rigid motion model for image motion induced by six degrees of freedom in a pose of an imaging device capturing the first image, the second image, and the third image.

11. The computer program product of claim 1, wherein the motion model includes a deformable motion.

12. The computer program product of claim 1, wherein the motion model uses independent motion tracking for one or more subregions of the first image, the second image, and the third image.

13. The computer program product of claim 1, wherein the motion model uses one or more visible fiducials to track image differences.

14. The computer program product of claim 1, wherein registering includes registering downsampled instances of the first image and the second image, and calculating motion parameters to register the first image and the second image by scaling up the motion parameters from the downsampled instances to a scale of the first image and the second image.

15. The computer program product of claim 1, wherein registering includes recursively downsampling, registering, and scaling motion parameters for two or more down-sampled versions of the first image, the second image, and the third image.

16. The computer program product of claim 1, wherein registering includes dividing a pixel array for each of the first image, the second image, and the third image into a plurality of regions, and selecting, from each of the plurality of regions, one or more pixel locations for evaluating the cost function.

17. The computer program product of claim 1, wherein registering includes selecting a subset of pixel locations in a pixel array for each of the first image, the second image, and the third image to minimize the cost function, and further wherein selecting the subset of pixel locations includes selecting at least one of the subset of pixel locations based on a magnitude of the cost function at the one of the subset of pixel locations between the third image and the sum of the first image and the second image.

18. The computer program product of claim 1, wherein the sum of the first image and the second image includes a scaled sum of pixel intensities.

19. A method comprising:
capturing at least three images of a surface including two or more images captured under two or more different illumination conditions and a composite image of the surface while illuminated concurrently under each of the two or more different illumination conditions; and
registering the two or more images by applying a motion model while minimizing an image difference between the composite image and a sum of the two or more images.

20. The method of claim 19, wherein the two or more different illumination conditions include two or more different illumination directions.

21. The method of claim 19, wherein the two or more different illumination conditions include two or more different illumination wavelengths.

22. The method of claim 19, wherein the two or more different illumination conditions include two or more different illumination patterns.

23. The method of claim 19, wherein minimizing the image difference includes minimizing a cost function representing a difference between the composite image and the sum of the two or more images.

24. The method of claim 19, wherein registering the two or more images includes registering the two or more images with a multi-image registration algorithm.

25. The method of claim 19, wherein registering the two or more images includes minimizing an optimization function.

26. The method of claim 19, wherein the two or more images include three images.

27. The method of claim 19, wherein the two or more images include six images.

28. The method of claim 19, wherein registering the two or more images includes aligning a first group of the two or more images to one another in a first image registration, registering a second group of the two or more images to one another in a second image registration, and registering the first image registration to the second image registration in a third image registration.

29. The method of claim 19, further comprising calculating an initial estimate for a displacement of the motion model based on an input from an inertial measurement unit.

30. The method of claim 19, further comprising calculating an initial estimate for a displacement of the motion model based on one or more fiducials visible in each of the two or more images.

31. The method of claim 19, further comprising calculating an initial estimate for a displacement of the motion model based on an evaluation by a machine learning model trained to associate one or more predetermined misalignments with one or more visual artifacts in a combination of images illuminated under the two or more different illumination conditions.

32. A system comprising:
a retrographic sensor including a deformable medium with a sensing surface, the deformable medium formed of an optically clear, deformable material and the sensing surface covering a portion of the deformable medium and the sensing surface providing a reflective surface visible through a second surface of the deformable medium;
a camera positioned to capture images of the reflective surface through the second surface of the deformable medium;
an illumination system configured to independently illuminate the sensing surface through the deformable medium from each of three or more directions about an optical axis of the camera, thereby providing directional illumination of the sensing surface; and
processing circuitry configured to:
control the camera and the illumination system to capture an image of the sensing surface with the camera during an illumination of the sensing surface individually from each of the three or more directions, thereby providing three or more images of the sensing surface,
control the camera and the illumination system to capture a composite image of the sensing surface while illuminated concurrently from all of the three or more directions,
register the three or more images by applying a motion model while minimizing an image difference between the composite image and a sum of the three or more images, thereby providing a registration aligning the three or more images, and
recover a three-dimensional shape of the sensing surface using shape-from-shading.

33. The system of claim 32, wherein the processing circuitry includes a controller for the camera and the illumination system.

34. The system of claim 32, wherein the processing circuitry includes a cloud computing resource configured to receive the three or more images and the composite image, to register the three or more images, and to recover the three-dimensional shape of the sensing surface using shape-from-shading and the registration aligning the three or more images.

35. The system of claim 32, further comprising a substrate for the retrographic sensor, wherein:
the deformable medium is disposed on the substrate,
the substrate is formed of a rigid, optically clear material mechanically supporting the deformable medium, and
the substrate is positioned between the deformable medium and the camera.

36. The system of claim 32, wherein the processing circuitry is configured to obtain one or more additional images under different illumination conditions and to illumination demultiplex the three or more images, the composite image, and the one or more additional images to obtain surface normal values from the sensing surface at a greater resolution than a nominal resolution of the camera.

37. The system of claim 32, wherein the processing circuitry is configured to obtain one or more additional images under different illumination conditions and to illumination demultiplex the three or more images, the composite image, and the one or more additional images to reduce pixel noise in the three or more images and the composite image.
